(19) United States
(12) Patent Application Publication
(10) Pub. No.: US 2018/0263425 A1
(43) Pub. Date: Sep. 20, 2018

(54) CUTTING BOARD WITH ACCESSORIES

(71) Applicant: Kitchen Innovations Inc., King City (CA)

(72) Inventors: Robert G. Dickie, King City (CA); Bartek Zalewski, King City (CA)

(73) Assignee: Kitchen Innovations Inc.

(21) Appl. No.: 15/461,751

(22) Filed: Mar. 17, 2017

(51) Int. Cl. A47J 47/00; G01G 19/52

(52) U.S. Cl. CPC A47J 47/005; G01G 19/52

(57) ABSTRACT

A cutting board, a plurality of accessories and a method of use is disclosed. The board includes a base with top and bottom surfaces and a hole defined therein. A retaining wall provided on the base partially circumscribes the hole. Wedge-shaped regions of a back wall and a side wall taper outwardly from the retaining wall. Foodstuffs cut on the base are moved toward the hole and the wedge-shaped regions and curved retaining wall funnel the cut foodstuffs through the hole. A scale assembly may be placed into a recess provided in the underside of the cutting board such that a visual display extends through the hole. Cut foodstuffs are constantly weighed by the scale. A container may be positioned under the hole and be engaged with the cutting board. An overlay assembly may be placed on the top surface of the base to provide an additional removable cutting surface.

### BACKGROUND

### Technical Field

This invention relates generally to kitchen utensils. More particularly, this invention is directed to a cutting board. Specifically, the invention is directed to a cutting board that has a base that defines a hole therein, where the hole is partially circumscribed by a retaining wall and where a back and side wall of the base extend upwardly from the base and are connected to the retaining wall to funnel cut foodstuffs into the hole. The cutting board may be engaged with an accessory such as a scale assembly, a container or an overlay assembly.

### Background Information

Cutting boards are used to provide a cutting surface upon which to cut or chop foodstuffs and to therefore protect countertops from potential damage from knife cuts. Cutting boards also aid in keeping countertops clean and sanitary as foodstuffs are not directly prepared on the countertop.

### SUMMARY

While a wide variety of shapes and sizes of cutting boards have been proposed in the prior art, there remains a need in the art for a cutting board that provides ease of use and efficient clean-up.

The cutting board, a plurality of accessories and a method of use disclosed herein provides such ease of use, efficient clean-up and greater functionality than previously known cutting boards. The present cutting board includes a base with top and bottom surfaces and a hole defined therein. A retaining wall provided on the base partially circumscribes the hole. Wedge-shaped regions of a back wall and a side wall taper outwardly from the retaining wall, Foodstuffs cut on the base are moved toward the hole and the wedge-shaped regions and curved retaining wall funnel the cut foodstuffs through the hole. A scale assembly may be placed into a recess provided in the underside of the cutting board such that a visual display extends through the hole. Cut foodstuffs are constantly weighed by the scale. A container may be positioned under the hole and be engaged with the cutting board. An overlay assembly may be placed on the top surface of the base to provide an additional removable cutting surface.

In one aspect, the present disclosure may provide a cutting board comprising a base having a top surface and a bottom surface; a hole defined in the base, wherein the hole extends between the top surface and the bottom surface; and a retaining wall provided on the base; said retaining wall partially circumscribing the hole. The retaining wall may extend for a distance above the top surface of the base or for a distance below the bottom surface of the base; or for a distance above the top surface of the base and a distance below the bottom surface of the base. The retaining wall may be arcuate in shape and have a top end, a bottom end; an arcuate inner surface and an arcuate outer surface, wherein the inner and outer surfaces extend between the top end and the bottom end. The top end of the retaining wall may be displaced laterally outwardly from the bottom end of the retaining wall.

The base of the cutting board has a perimeter that includes a front wall, a back wall, a left side wall and a right side wall; and a region of one or more of the back wall and the right side wall or the left side wall extends for a distance above the top surface of the base. The region may be wedge-shaped and may be integral with or connected to the retaining wall and tapers away from the retaining wall. The retaining wall is shaped to funnel objects through the hole defined in the base. At least one notch defined in a bottom end of the retaining wall or at an intersection of the bottom end of the retaining wall and a back wall, a right side wall or a left side wall provided on the base. The retaining wall tapers from a top end to a bottom end thereof and bulges laterally outwardly from a perimeter of the base and the hole is defined adjacent the perimeter. One or more of the back wall, front wall, left side wall and right side wall is concave and is adapted to receive fingertips of a user therein. The bottom surface, the back wall, the front wall, the left side wall and the right side wall define a recessed region.

In another aspect, the present disclosure may provide in combination, a cutting board; and an accessory selectively engageable with the cutting board; wherein the cutting board comprises a base having a top surface and a bottom surface; a hole defined in the base, wherein the hole extends between the top and bottom surfaces; and a retaining wall provided on the base; said retaining wall partially circumscribing the hole. The accessory may be a scale assembly; a container or an overlay assembly.

When the accessory is a scale assembly, a first part of the scale assembly extends for a distance into the hole defined by the base and a second part of the scale assembly extends for a distance beneath the bottom surface of the base. The combination may further include a locking mechanism provided on one or both of the scale assembly and the cutting board; and wherein the locking mechanism is engaged to lock the cutting board and scale assembly together; and the locking mechanism is disengaged to release the cutting board from the scale assembly. The first part of the scale assembly that extends into the hole includes an angled face that has a display screen thereon. A trough may be defined on a top surface of the second part of the scale assembly and the trough may be at least partially positioned beneath a region of the hole defined in the cutting board. One or more strain gauges may be provided in the second part of the scale assembly and a limiting stop may also be provided in the second part of the scale assembly in a location vertically above at least a bendable region of the one or more of the strain gauges.

When the accessory is a container, the container is positionable beneath the hole in the cutting board and extends for a distance downwardly from the bottom surface of the base when the container is engaged with the cutting board. The base defines a perimeter wall that extends downwardly from the bottom surface thereof; and a notch is defined in a bottom end of the retaining wall or in a bottom edge of the perimeter wall adjacent the retaining wall; and wherein an upper rim of the container is receivable in the notch.

When the accessory is the overlay assembly, the overlay assembly includes a wall with a top surface and a bottom surface, wherein the bottom surface of the wall is positioned above the top surface of the base of the cutting board. The overlay assembly defines a hole therein that extends between the top surface and bottom surface of the wall; and wherein the hole in the overlay assembly is located on the wall so as to be aligned with the hole defined in the cutting board when the overlay assembly is placed on the top surface of the cutting board. The overlay assembly further defines a retaining wall that is complementary in size and shape to the retaining wall of the cutting board and is placed in abutting contact with an inner surface of the retaining wall on the cutting board when the overlay assembly is placed on the top surface of the cutting board. The overlay assembly retaining wall has a top edge that extends over a top end of the cutting board's retaining wall. The overlay assembly includes a back wall and a side wall that taper downwardly away from the overlay assembly's retaining wall; and a region of each of the overlay assembly's back wall and side wall overlap a back wall and a side wall on the cutting board. At at least one tab provided on the wall and extends outwardly therefrom in a same plane; and wherein the at least one tab extends outwardly beyond an outer perimeter of the base of the cutting board when the wall of the overlay is placed on the top surface of the base. At least one rib is provided on a lower surface of the at least one tab and is positioned to contact the outer perimeter of the base when the wall of the overlay assembly is placed on the top surface of the base.

In another aspect, the present disclosure may provide a method of measuring a quantity of foodstuffs comprising providing a cutting board having a base with a top surface and a bottom surface; a hole defined in the base and extending between the top and bottom surfaces; and a retaining wall provided on the base; said retaining wall partially circumscribing the hole; selectively placing the cutting board over a top wall of a scale assembly; locking the cutting board to the scale assembly with a locking mechanism; cutting foodstuffs on the top surface of the base; and weighing the cut foodstuffs on the top surface of the base with a scale provided in the scale assembly and without disengaging the cutting board from the scale assembly.

The method may further comprise disengaging the locking mechanism; separating the cutting board from the scale assembly; and moving cut foodstuffs across the cutting board to the hole; and funneling the cut foodstuffs through the hole and off the cutting board. The method may further include extending a display on the scale assembly into the hole of the cutting board; and viewing a weight of the cut foodstuffs by observing the display in the hole. The method may further comprise immersing the locked cutting board and scale assembly in water to clean the top surface of the cutting board; and keeping electronics in the scale assembly dry while immersing the locked cutting board and scale assembly.

### BRIEF DESCRIPTION OF THE SEVERAL VIEWS OF THE DRAWINGS

Sample embodiment of the disclosure are set forth in the following description, is shown in the drawings and is particularly and distinctly pointed out and set forth in the appended claims.

FIG. 1 is a top perspective view of a cutting board in accordance with an aspect of the present invention;

FIG. 2 is a top plan view thereof;

FIG. 3 is a bottom plan view thereof;

FIG. 4 is a right side elevation view thereof;

FIG. 5 is a left side elevation view thereof;

FIG. 6 is a front elevation view thereof;

FIG. 7 is a back elevation view thereof;

FIG. 8 is a transverse cross-section of the cutting board taken along line 8-8 of FIG. 2; and

FIG. 9 is a longitudinal cross-section of the cutting board taken along line 9-9 of FIG. 2;

FIG. 10 is a top perspective view of the cutting board of FIG. 1 shown engaged with a first accessory, wherein the first accessory is a scale assembly;

FIG. 11 is a top plan view of the cutting board engaged with the scale assembly;

FIG. 12 is a bottom plan view thereof;

FIG. 13 is an exploded top view of the cutting board and the scale assembly;

FIG. 14 is an exploded bottom view of the cutting board and the scale assembly;

FIG. 15 is a top plan view of the scale assembly shown on its own;

FIG. 16 is a right side elevation view of the scale assembly shown on its own;

FIG. 17 is a cross-section of the scale assembly taken along line 17-17 of FIG. 15;

FIG. 18A is an exploded bottom perspective view of one of the strain gauges used in the scale assembly;

FIG. 18B is a bottom perspective view of strain gauge assembled and positioned for installation in the upper housing of the scale assembly;

FIG. 19A is a cross-section of the strain gauge and scale assembly taken along line 19A-19A of FIG. 12 and showing the strain gauge in a first position;

FIG. 19B is a cross-section of the strain gauge and scale assembly taken along line 19A-19A of FIG. 12 and showing the strain gauge in a second position with the stop limiting the movement thereof;

FIG. 20 is an exploded top perspective view of the cutting board taken from the back of the board and of a second accessory, where the second accessory is a container;

FIG. 21 is a cross-section of the cutting board and container taken along line 21-21 of FIG. 20;

FIG. 22 is a top perspective view of the cutting board of FIG. 20 engaged with the container; and

FIG. 23 is a cross-section of the cutting board and container taken along line 23-23 of FIG. 22;

FIG. 24 is an exploded top back perspective view of the cutting board engaged with a third accessory, where the third accessory is an overlay assembly;

FIG. 25 is a top front perspective view of the cutting board engaged with the overlay assembly;

FIG. 26 is a top plan view thereof;

FIG. 27 is a cross-section of the cutting board and overlay assembly taken along line 27-27 of FIG. 26;

FIG. 28 is a cross-section of the cutting board and overlay assembly taken along line 28-28 of FIG. 26;

FIG. 29 is a bottom plan view of the cutting board engaged with the overlay assembly;

FIG. 30 is an enlargement of the highlighted region of FIG. 29;

FIG. 31 is top plan view of the overlay assembly shown on its own; and

FIG. 32 is a bottom plan view of the overlay assembly shown on its own.

Similar numbers refer to similar parts throughout the drawings.

### DETAILED DESCRIPTION

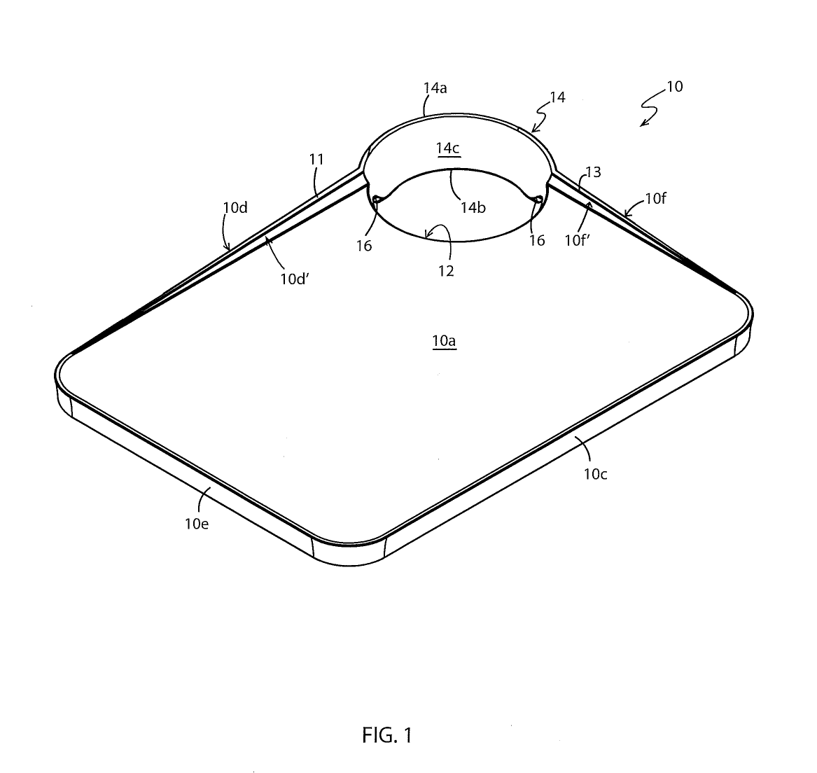

Referring to FIGS. 1-9 there is shown a cutting board in accordance with an aspect of the present invention, generally indicated at 10. Cutting board 10 may be a one piece, monolithic unit. Cutting board 10 may be fabricated by injection molding a plastic, such as high density polyethylene (HDPE), or may be fabricated in any other manner or from any other plastic or material that is suitable for use with foodstuffs and that is also suitable as a cutting surface. The monolithic, unitary design of cutting board 10 makes the board dishwasher safe. This is an advantage because over time cutting boards may develop tiny cuts that trap food particles therein and being able to clean cutting board 10 in a dishwasher helps ensure a sanitary cutting surface. Being dishwasher safe also makes cleaning cutting board 10 simpler and easier.

Cutting board 10 as illustrated herein is designed and dedicated particularly for use by right-handed people since about 90% of the world's population is right-handed. It will be understood that a dedicated cutting board for left hand users will be a mirror image of the design illustrated herein.

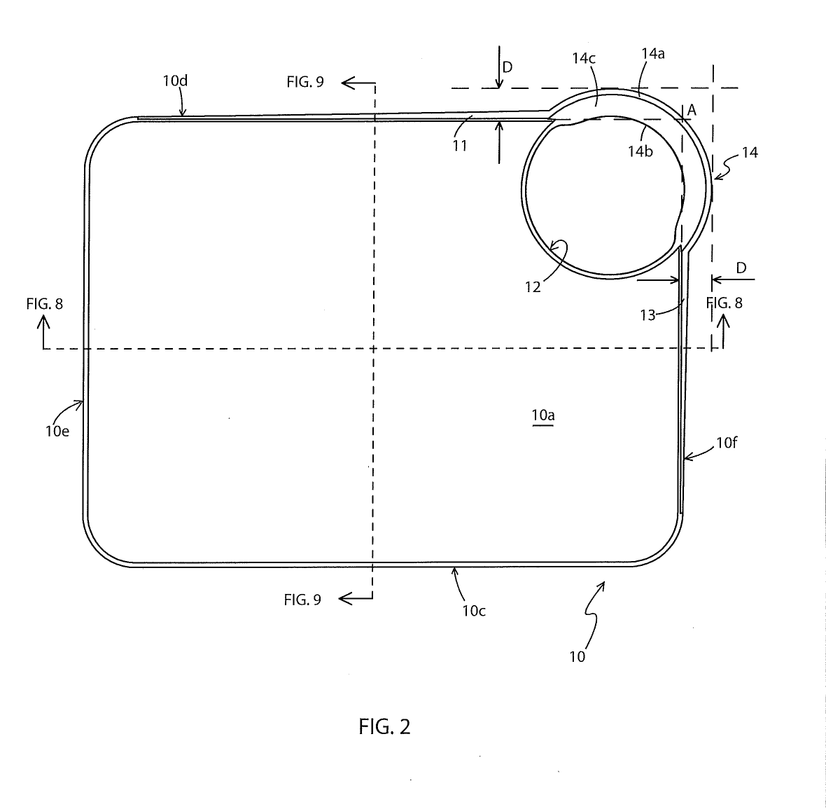

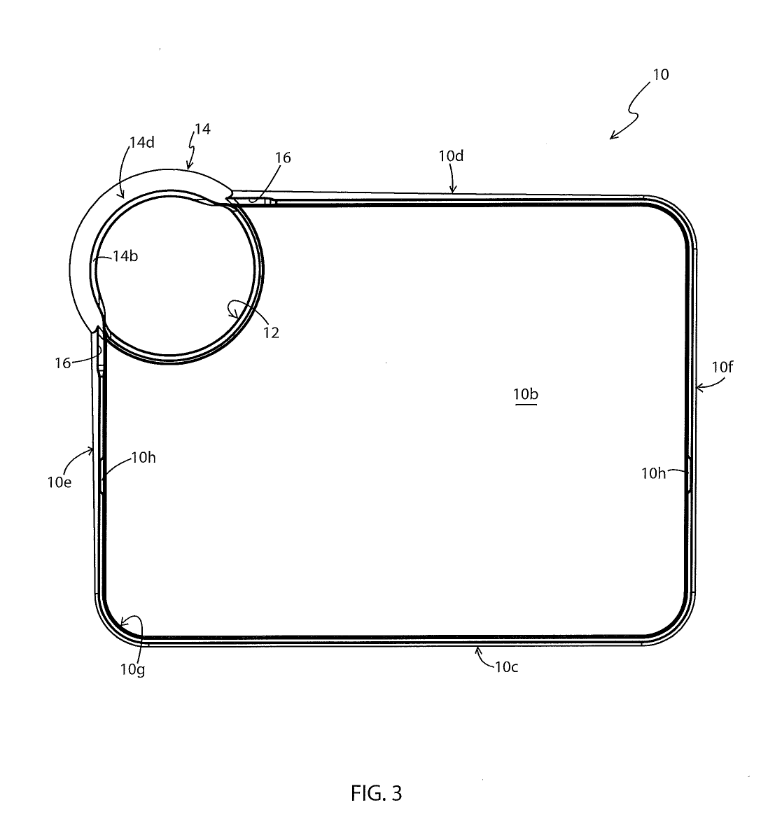

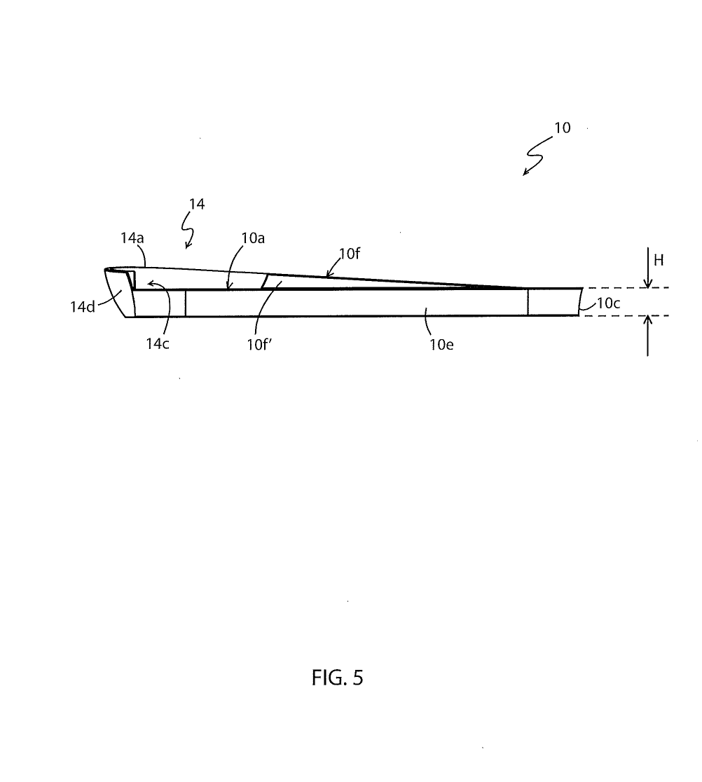

Cutting board 10 comprises a base that has a top surface 10a and a bottom surface 10b (FIG. 3). The base may be rectangular when viewed from above, such as in FIG. 2 and includes a perimeter made up from a front wall 10c, a back wall 10d, a left side wall 10e and a right side wall 10f. Front, back, left side and right side walls all extend outwardly and downwardly from base, extending downwardly for a distance below the bottom surface 10b thereof. Front, back, left side and right side walls 10c, 10d, 10e and 10f may all be oriented at right angles to the top surface 10a of the base of cutting board 10. Front wall 10c and back wall 10d may be longer than left and right side walls 10e, 10f or vice versa. Front wall 10c and left side wall 10e may be of generally the same height “H” (FIG. 5) as measured by the distance between bottom surface 10b and top surface 10a.

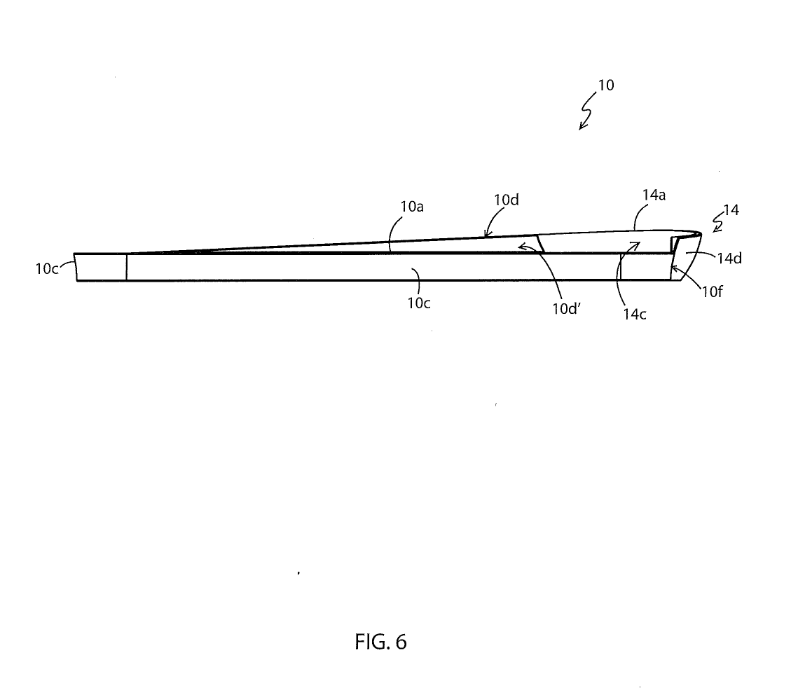

A region of back wall 10d and right side wall 10f, however, may extend for a distance outwardly beyond top surface 10a. In particular, one or both of back wall 10d and right side wall 10f may be wedge-shaped. For instance, right side wall 10f may increase in height from proximate front wall 10c and moving towards back wall 10d. This may be seen in FIGS. 1 and 5. Similarly, back wall 10d may increase in height from proximate left side wall 10e and moving towards right side wall 10f. This may be seen in FIGS. 1 and 6. The wedge-shaped region of right side wall 10f′ may form a lip 10f′ that extends a distance above top surface 10a and the wedge-shaped region of back wall 10d may form a lip 10d′ that extends for a distance above top surface 10a.

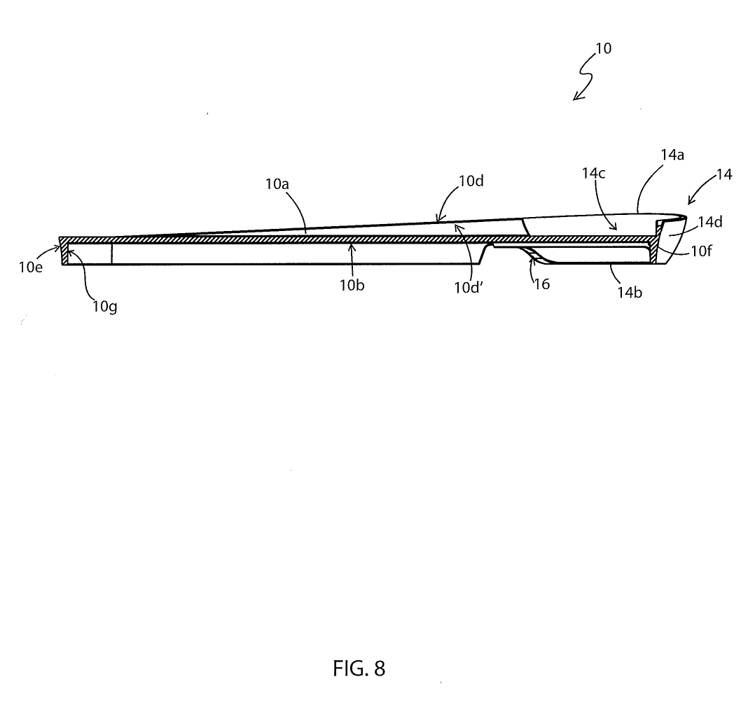

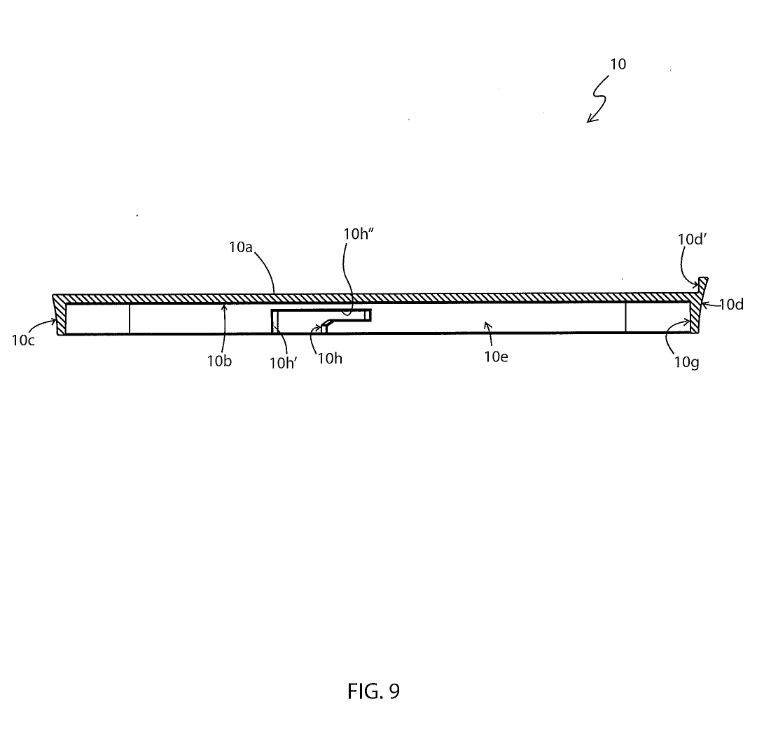

As indicated above, each of front wall 10c, back wall 10d, left side wall 10e and right side wall 10f may extend for a distance downwardly below bottom surface 10b. This may be seen in FIGS. 8 and 9. The regions of front wall 10c, back wall 10d, left side wall 10e and right side wall 10f that extend below bottom surface 10b, as well as bottom surface 10b, bound and define a recessed region 10g. The cutting surface of top surface 10a is thus raised a distance above a counter surface upon which cutting board 10 rests during use. This makes it less likely that a knife used on the cutting surface of top surface 10a will accidentally cut the counter surface. The configuration of cutting board 10 allows the board 10 to sit flat on a counter surface. Recessed region 10g serves other purposes such as providing room for a mechanical locking mechanism to selectively attach cutting board 10 to another device, as will be later described herein. The mechanical locking mechanism may comprise a depression, such as depression 10h, formed in cutting board 10 and some type of flange or blade provided on the other device or vice versa. The cutting board 10 and other device may then be engaged with each other by receiving the flange or blade into the depression 10h.

FIGS. 3 and 9 show that an interior surface of each of the left side wall 10e and right side wall 10f define a depression 10h therein that may include a wider mouth region, designated by the number 10h′ and a narrower slot designated by the number 10h″. The purpose of depression 10h will be discussed later herein.

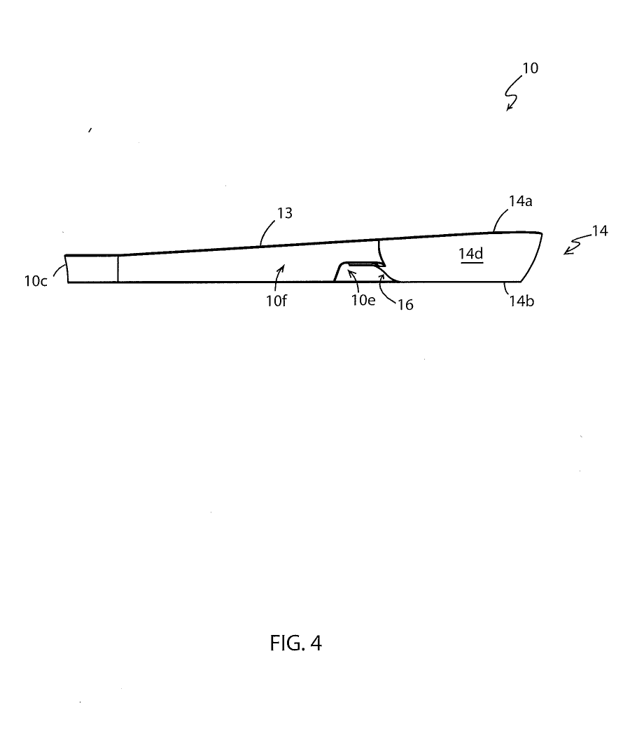

FIGS. 4-9 show that front wall 10c, back wall 10d, left side wall 10e and right side wall 10f may all be slightly concave in shape. This concavity aids a user in gripping cutting board 10, lifting cutting board 10 off a surface and holding onto the board 10 when moving foodstuffs off top surface 10a.

In accordance with an aspect of the present invention, a hole 12 is defined in cutting board 10. Since cutting board 10 as illustrated is designed for use by right-handed people and since cutting board 10 is shown to be generally rectangular in shape, hole 12 may be defined in the right hand back corner of cutting board 10. In particular, hole 12 may be defined in the region where right side wall 10f of cutting board 10 will typically intersect back wall 10d. Hole 12 may extend from top surface 10a through to bottom surface 10b and is in fluid communication with recessed region 10g. Hole 12 may be generally circular in shape when viewed from above, as in FIG. 2, although any other desired shape of hole may be defined in cutting board 10.

It will be understood that if the cutting board is designed for specific use by left-handed people, then the hole would be defined in the left hand back corner of cutting board 10 where left side wall 10e will typically intersect back wall 10d. A dedicated cutting board for left-handed users will be a mirror image of the cutting board 10 illustrated in the attached figures.

Lips 10f′ and 10d′ that extend upwardly from top surface 10 aid in preventing foodstuffs from sliding off the back and right sides of cutting board 10 during use of board 10. Lips 10f′ and 10d′ serve an additional purpose in that they aid in directing or funneling cut foodstuffs towards hole 12 when those foodstuffs are pushed by the user toward the back right hand corner of cutting board 10. This will be further discussed later herein.

In accordance with yet another aspect of the invention, a retaining wall 14 may be provided on cutting board 10. Retaining wall 14 may bulge laterally a distance “D” laterally outwardly beyond back wall 10d and right side wall 10f. Retaining wall 14 may partially circumscribe hole 12 and thus form a boundary around at a least a region of hole 12. Retaining wall 14 has a top end 14a, a bottom end 14b, an inner surface 14c and an exterior surface 14d. Retaining wall 14 may extend for a distance above top surface 10a or for a distance below bottom surface 10b; or may extend for a distance above top surface 10a and for a distance below bottom surface 10b.

Retaining wall 14 may be arcuate or curved along its length from a connection with back wall 10d to a connection with right side wall 10f. (In a left-handed cutting board the retaining wall will be arcuate and extend from a connection with back wall 10d to a connection with left side wall 10e.) Retaining wall 14 may be generally semi-circular when viewed from above as in FIG. 2. An upper end 11 (FIG. 1) of back wall 10d may be substantially continuous with top end 14a of retaining wall 14. Similarly, an upper end 13 of right side wall 10f may be substantially continuous with top end 14a of retaining wall 14. Lips 10d′ and 10f′ gently rise above the cutting surface of top surface 10a and meet top end 14a of retaining wall 14. Lips 10d′ and 10f′ start after the corner radius with left side wall 10e and front wall 10c, respectively, and rise to about ⅜″ and join top end 14a. In other words, the wedge-shaped lips 10d′ and 10f′ taper away from retaining wall 14. Retaining wall 14 continues to extend upwardly even further above top surface 10a than the highest regions of back wall 10d and right side wall 10f. Bottom end 14b of retaining wall 14 may be in the same plane as bottom surface 10b of cutting board 10. This can be seen in FIGS. 4-9.

The radius of curvature of retaining wall 14 is such that the wall itself extends outwardly for a distance beyond each of back wall 10d and right side wall 10f. In particular, wall 14 curves upwardly from bottom end 14b towards top end 14a. Additionally, wall 14 angles outwardly such that top end 14a of wall 14 is displaced a distance laterally and longitudinally outwardly away from bottom end 14b. This is best seen in FIG. 2 where it is shown that part of bottom end 14b of wall 14 is generally aligned with an interior surface of back wall 10d and another part of bottom end 14b is generally aligned with an interior surface of right side wall 10f. A part of top end 14a of wall 14 is displaced a distance “D” outwardly from the exterior surface of back wall 10d and from the exterior surface of right side wall 10f.

FIG. 2 also shows that bottom end 14b of wall is not shaped in the same manner as top end 14a thereof. Top end 14a has a radius of curvature that is substantially constant around the curve, thereby giving top end 14a a semi-circular shape. Bottom end 14b, on the other hand, has certain regions with a tighter radius of curvature than the rest of bottom end 14b or top end 14a. So the radius of curvature of the bottom end 14b is not constant around the curve. As a consequence, bottom end 14b is shaped so as to funnel foodstuffs moving through hole 12 in a particular direction.

Referring still to FIG. 2, if one extended the back wall 10d and right side wall 10f to meet at a 90 degree corner “A”, then hole 12 and retaining wall 14 would be about 80% contained within the squared off area but the bottom end 14b of retaining wall would be 100% within this squared off area. When a right-handed user holds a knife in their right hand and cuts food, they can pick up cutting board 10 and with the knife they can slide cut foodstuffs towards the top right hand corner of cutting board 10 and into hole 12. The user is able to simply move cut foods diagonally towards the top right corner (and hole 12) and the gradually rising lips 10d′ and 10f′ and retaining wall 14 corrals the food into the hole 12 without allowing the food to spilling off the back and right sides of cutting board 10. Because of lips 10d′, 10f′ and retaining wall 14, substantially all of the cut food is directed into the funnel-shaped hole 12 as the quantity of food grows taller as it is moved towards hole 12, the back wall 10d and right side wall 10f also get taller. Because back wall 10d and right side walls 10f are of substantially the same height as top surface 10a proximate the back left corner and front right corner of cutting board 10, there is still good cutting space on cutting board and a knife will not tend to hit the back and right side walls 10d, 10f because of the angle right-handed people tend to cut at.

Cutting board 10 is configured in such a way that minimal space is occupied by hole 12 and such that there is still sufficient cutting surface provided by top surface 10a. Right-handed people tend to cut off to the left or straight ahead so they tend not to cut very often in the top right hand corner of a cutting board. So, positioning hole 12 in the top right hand corner of cutting board is essentially placing the hole 12 in a region that typically is not used by right-handed people when cutting. (If the cutting board is fabricated specifically for left-handed people the opposite is true and the hole will be located in the top left hand corner of the cutting board.) Additionally, by making the retaining wall bulge slightly backwardly and to the right hand side of top surface 10a, the cutting surface on top surface 10a is maximized while still providing for easy gathering and dispensing of cut foodstuffs through hole 12. The configuration of cutting board 10 still makes the board suitable for sideways storage in a cabinet (i.e., with the board 10 standing on the front wall 10c, back wall 10b, left or right side walls 10e, 10f) as is done by so many people. Even though there is a slight bulge of retaining wall 14, the bulge is not sufficient to prevent cutting board 10 from being be stored on back wall 10b or right side wall 10f without tipping over

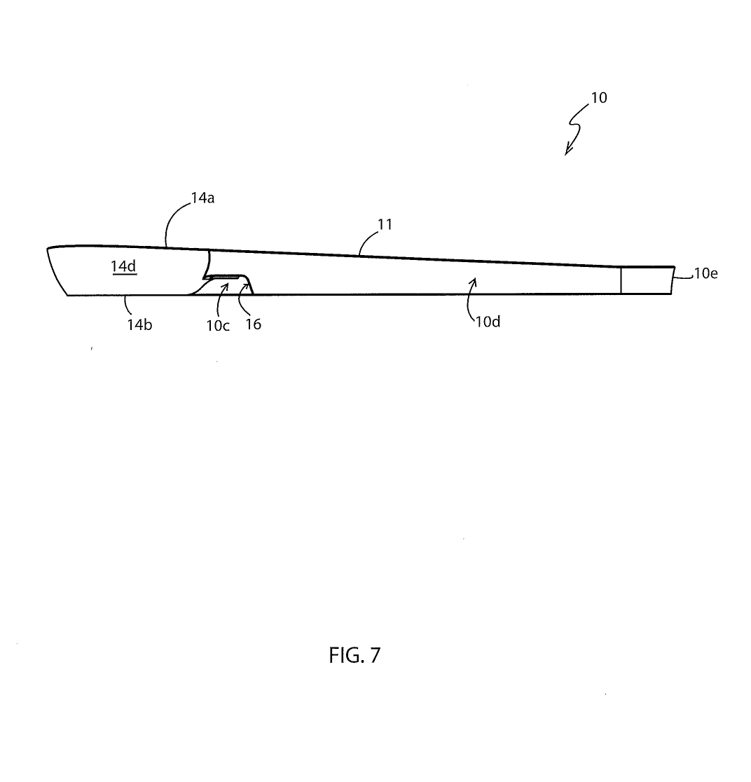

In accordance with another aspect of the present invention, bottom end 14b of retaining wall and/or bottom ends of back wall 10d and right side wall 10f define one or more notches 16 therein. Notches 16 are located in a region of back wall 10d and/or right side wall 10f that is located beneath bottom surface 10b of the base. Each notch 16 may be generally U-shaped when viewed from the side as in FIGS. 4 and 7. The purpose of notches 16 will be discussed later herein.

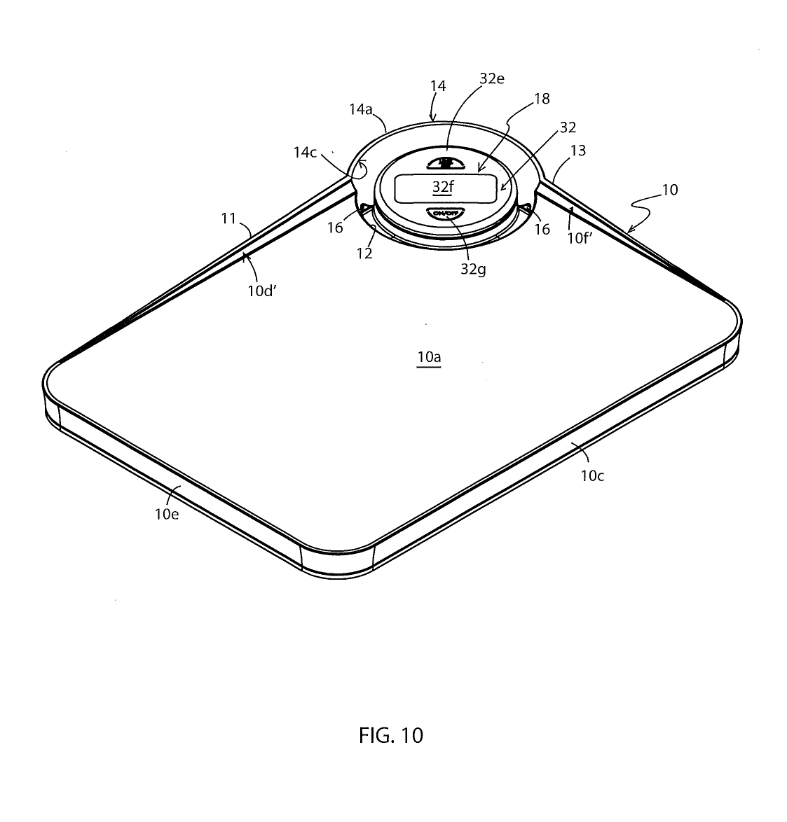

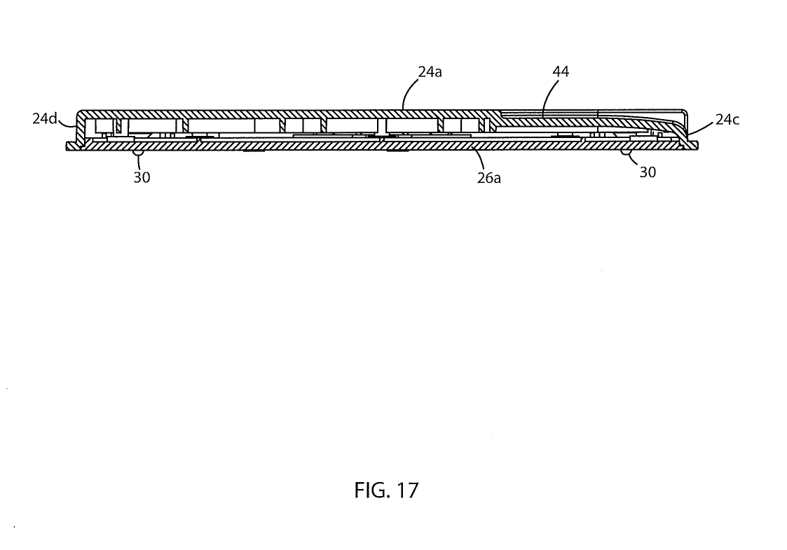

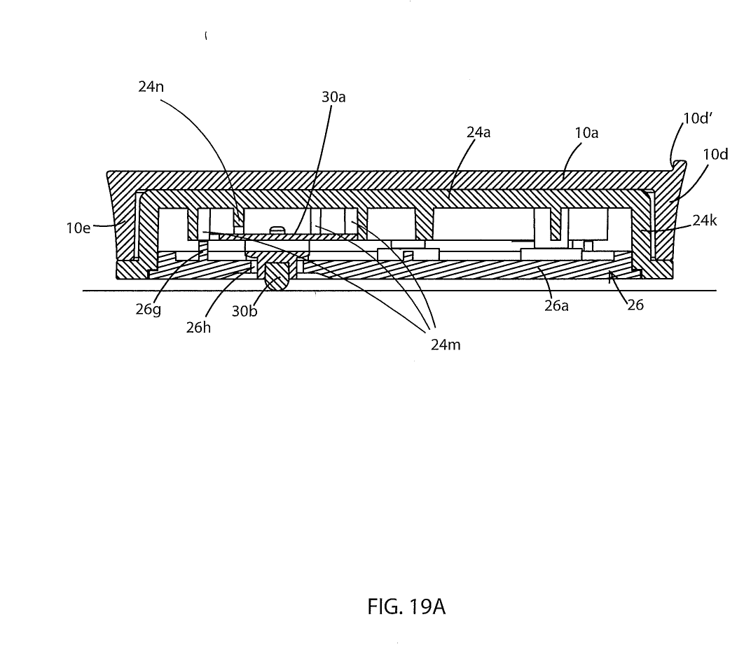

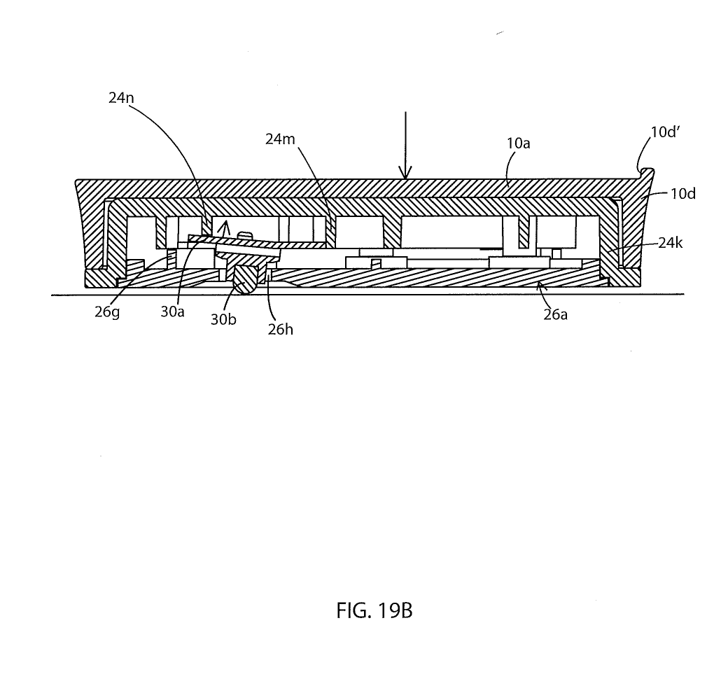

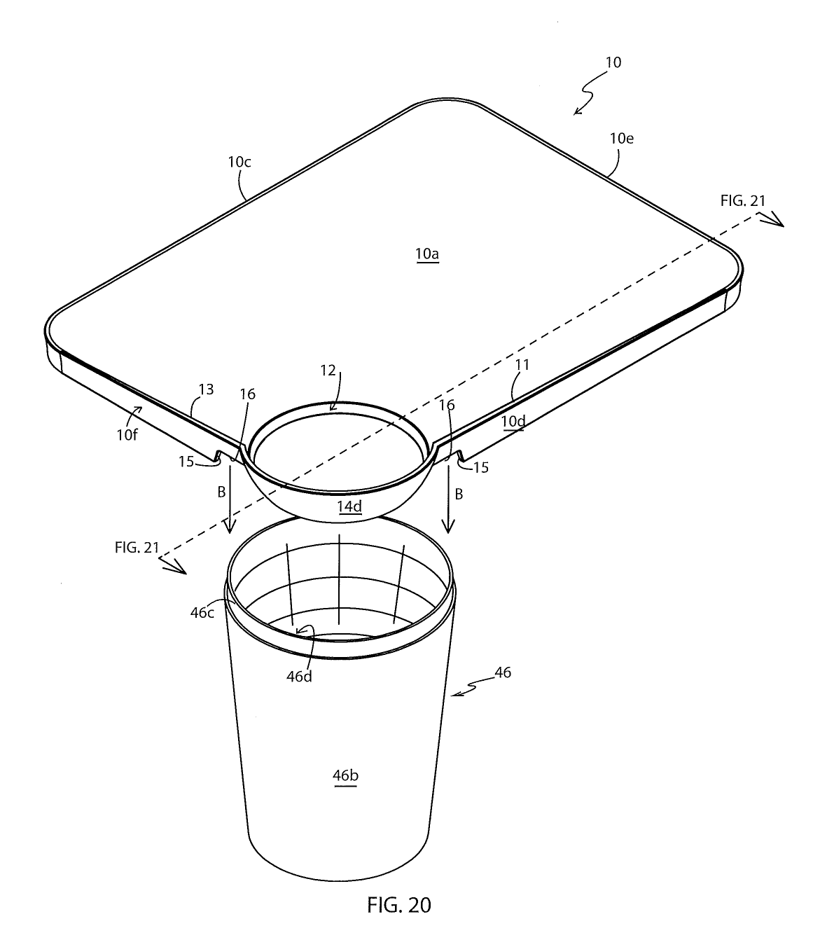

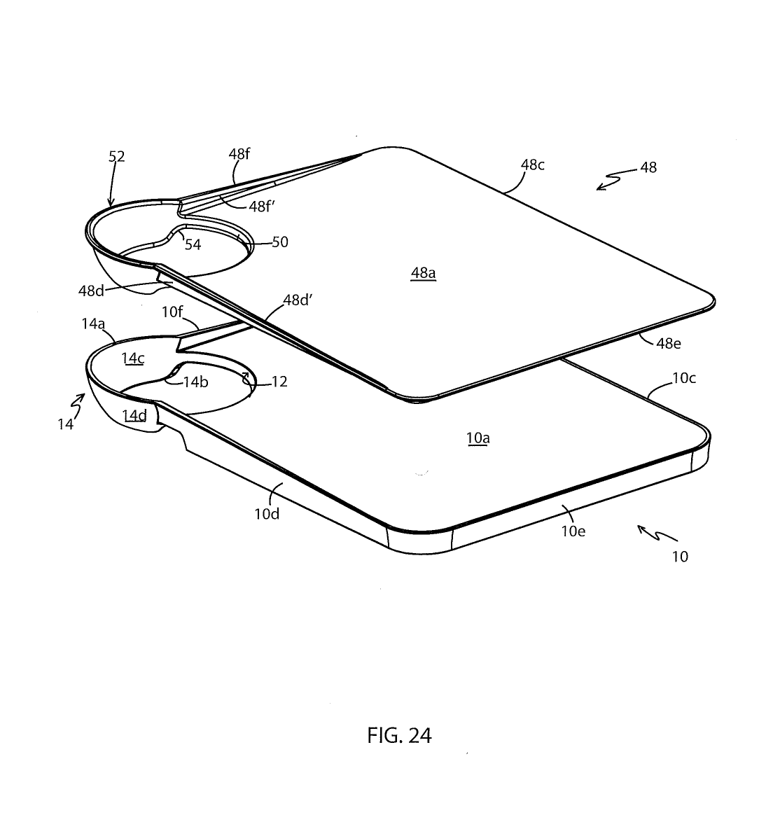

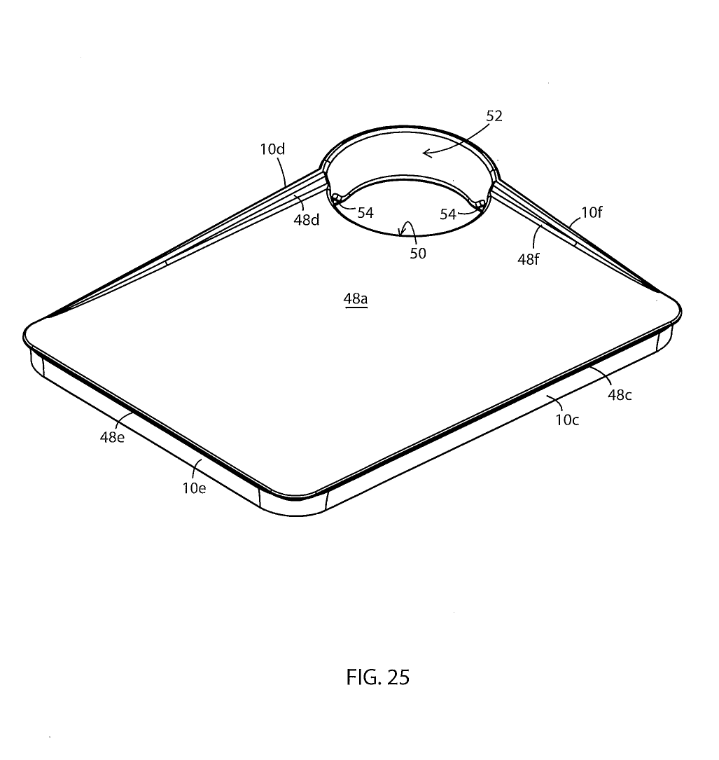

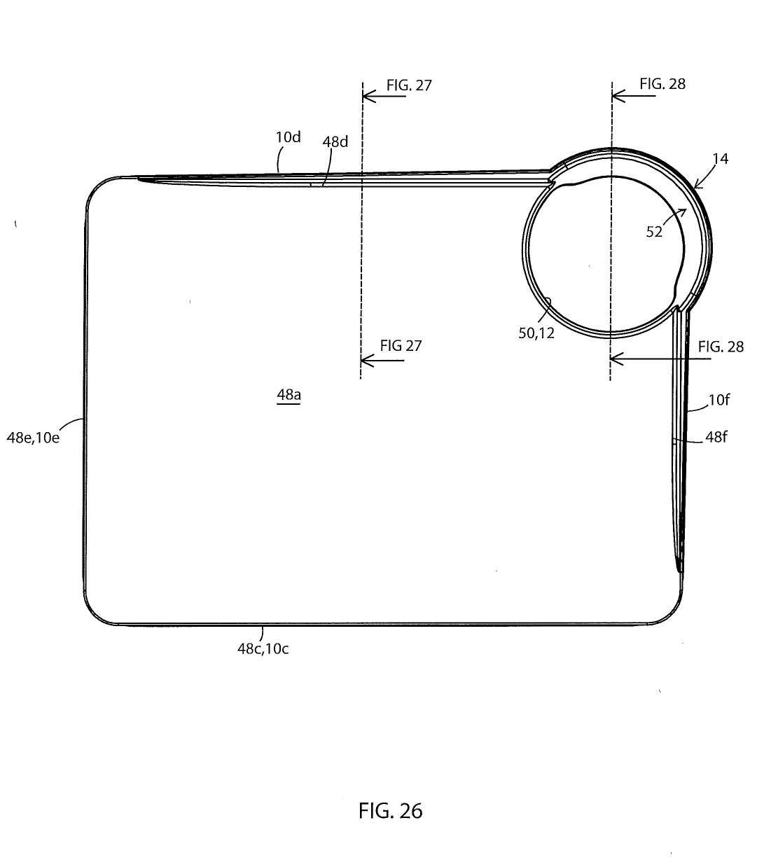

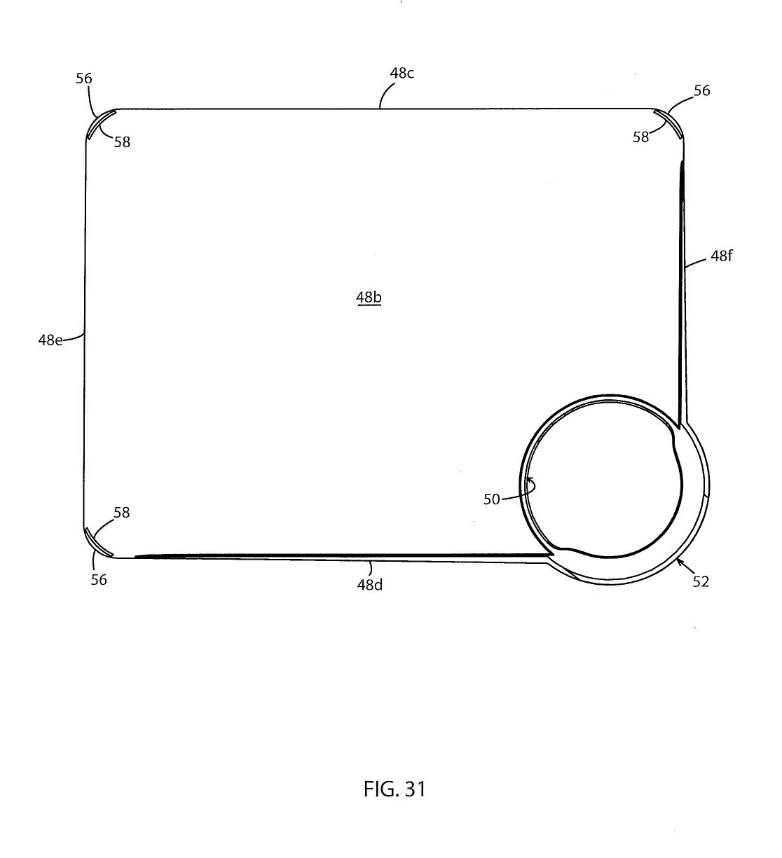

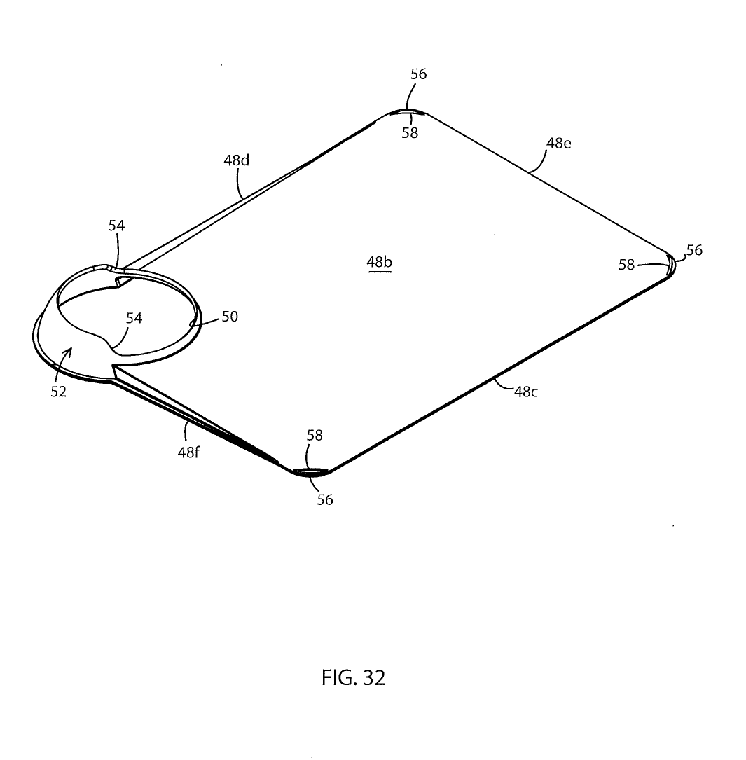

Cutting board 10 is designed to be used in conjunction with a variety of accessories that includes but is not limited to a scale assembly 18 (FIGS. 10-19), a container 46 (FIGS. 20-23), and an overlay assembly 48 (FIGS. 24-32).

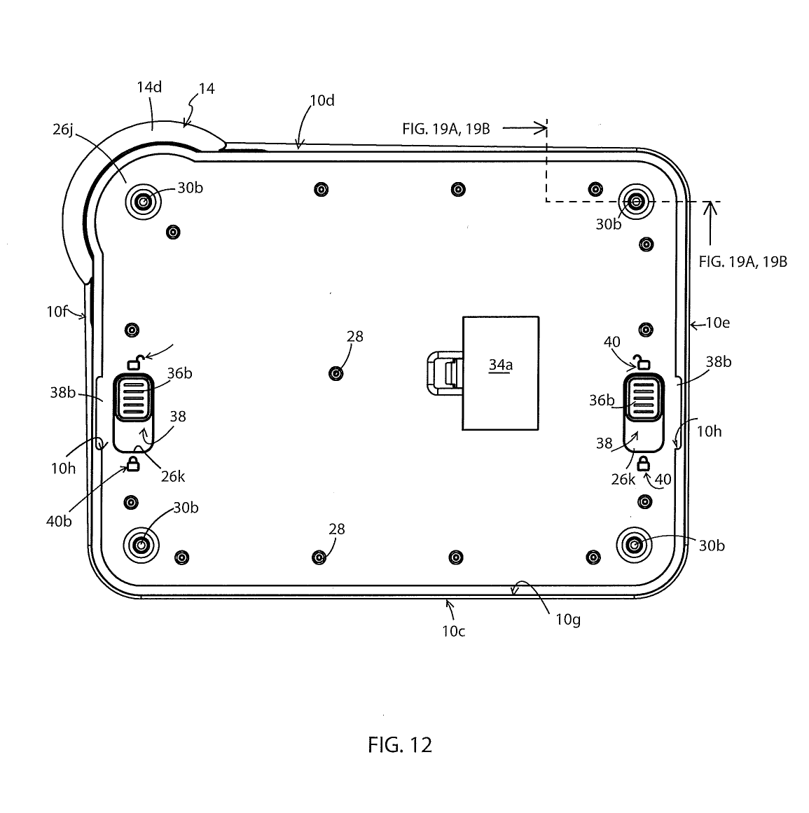

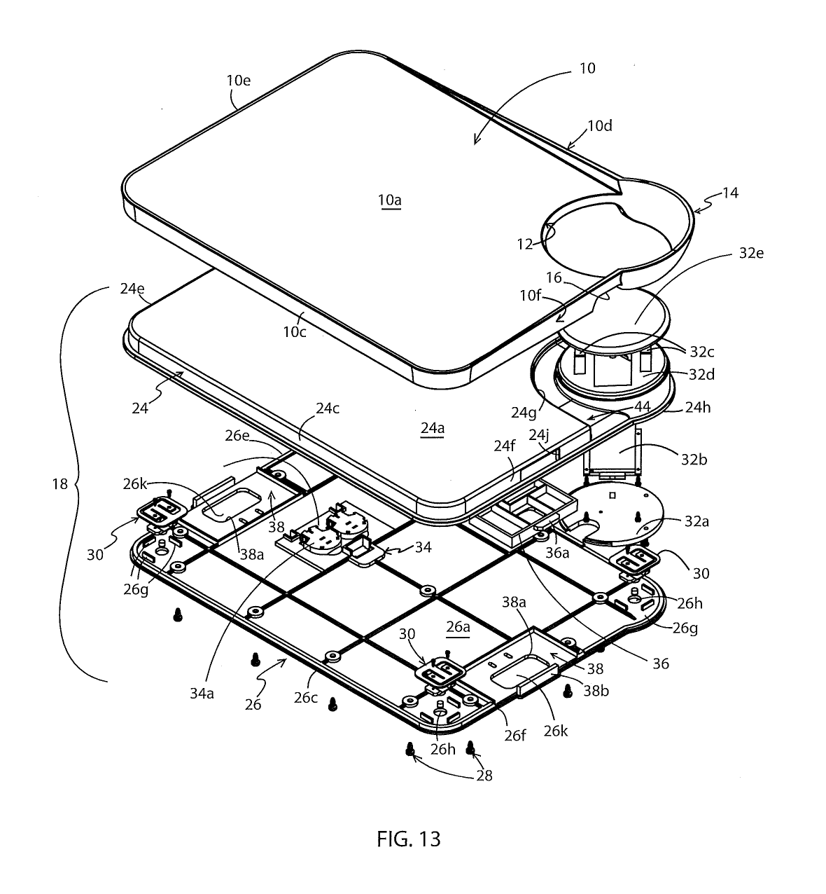

Referring to FIGS. 10-19, scale assembly 18 is shown in greater detail. Scale assembly 18 comprises an upper housing 24 and a lower housing 26 that are configured to be interlockingly engaged with each other. Upper and lower housings 24, 26 are sized so that when interlockingly engaged with each other then are able to be received in recessed region 10g of cutting board 10 (see FIGS. 12 and 13). Upper and lower housings 24, 26 may be secured to each other by fasteners 28 that pass through holes in lower housing 26 and into aligned holes in upper housing 24.

Upper housing 24 comprises a wall 24a with a front wall 24c, a back wall 24d, a left side wall 24e and a right side wall 24f extending downwardly therefrom. A hole 24g is defined in wall 24a and this hole 24g extends from an upper surface to a lower surface of wall 24a. Upper housing 24 also include a retaining wall 24h that is bulges slightly outwardly from upper housing 24 in a similar fashion to retaining wall 14 on cutting board 10. Retaining wall 24h may have similar dimensions and curvature to bottom end 14b of retaining wall 14. When upper housing 24 is received within recessed region 10g of cutting board 10, retaining wall 24h will be seated vertically beneath bottom end 14b of retaining wall 14. And hole 24g will be generally aligned with hole 12 in cutting board 10. Left and right side walls 24e, 24f of upper housing 24 may also define a pair of slots 24j therein that are positioned to align with depressions 10h in left and right side wall s 10e, 10f of cutting board 10.

A compartment wall 24k extends downwardly from a lower surface of wall 24a proximate the three corners that do not include hole 24g. Each compartment wall 24k defines a region of upper housing 24 into which a strain gauge 30 may be received. A plurality of ribs 24m, 24n may extend downwardly from the lower surface of wall 24a and into the space defined by compartment wall 24k. Ribs 24m may aid in retaining strain gauge 30 within the space defined by compartment wall 24k. Strain gauge 30 includes metal frame 30a, a foot 30b and a solid state sensor 30c. Ribs 24n may act as a stop that limits the movement of a metal frame 30a of strain gauge 30. This limitation by ribs 24n may aid in preventing damage to strain gauges 30 during the cutting of foodstuffs on the top surface 10a of cutting board 10. (Those cutting motions will tend to be transferred to top wall 24a of upper housing 24 and thereby potentially to strain gauges 30.

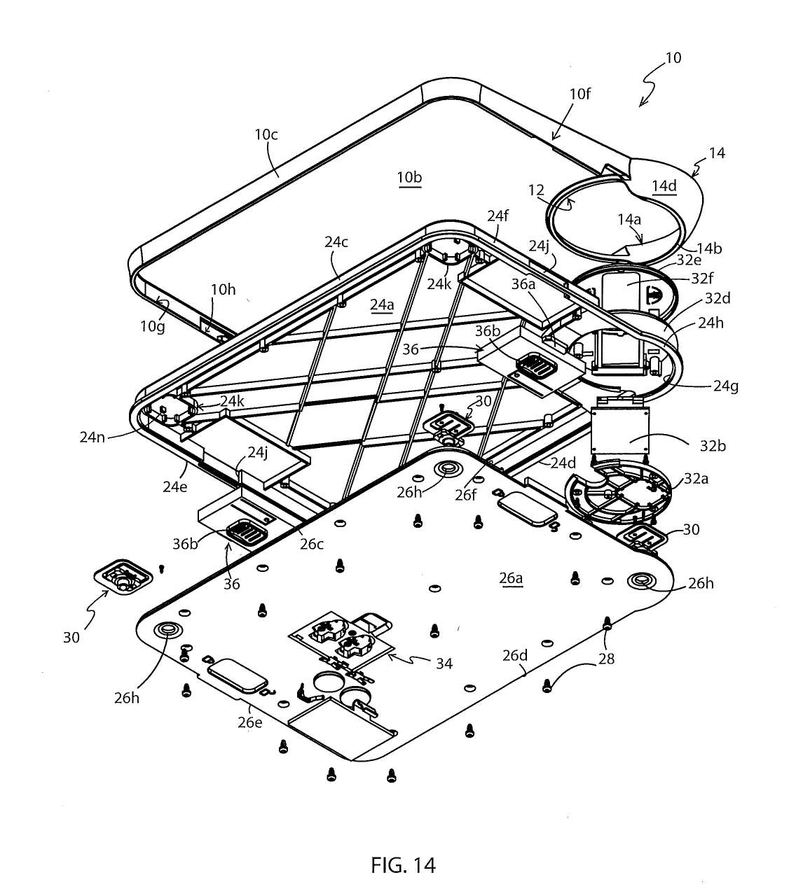

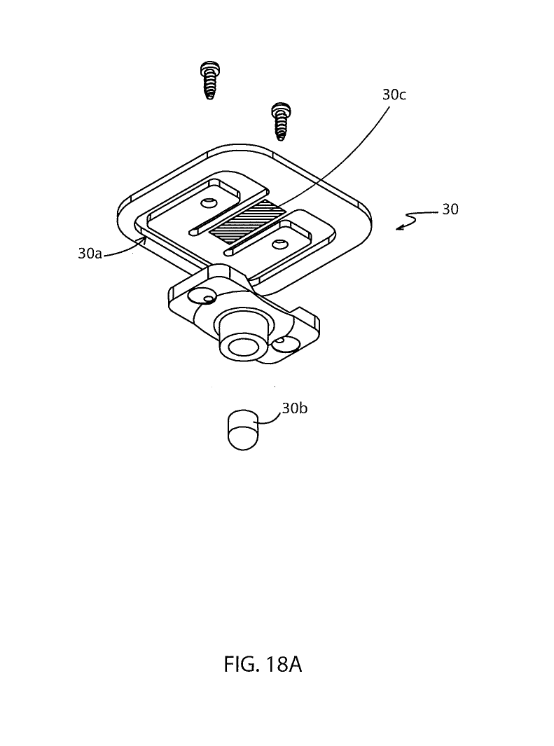

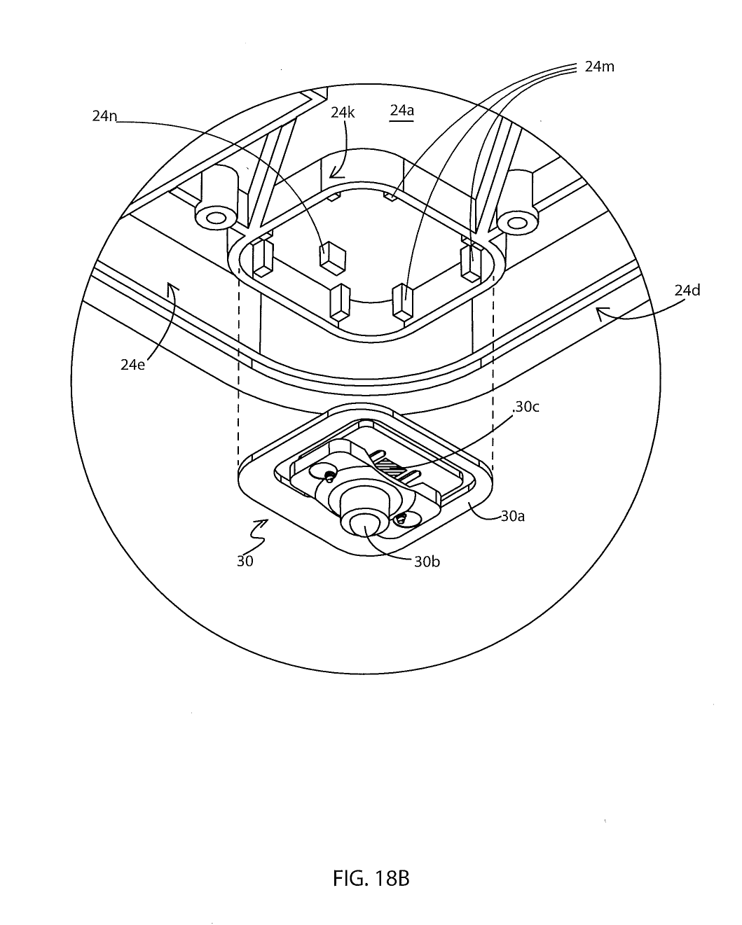

Lower housing 26 comprises a wall 26a with a front wall 26c, back wall 26d, left side wall 26e and right side wall 26f extending upwardly therefrom. A region of lower housing 26 that will be located opposite the space defined by compartment wall 24k on upper housing 24 includes a plurality of up upstanding ribs 26g to aid in seating strain gauge 30. A foot hole 26h (FIG. 14) is defined in lower housing 26 with foot hole 26h extending between the upper and lower surfaces of lower housing 26. A foot 30b (FIG. 18A) of strain gauge 30 extends through foot hole 26h to contact a surface of a counter upon which scale assembly 18 will stand.

FIG. 12 shows that lower housing 26 also includes a region 26j that has an outer perimeter shaped and sized to engage a bottom end of retaining wall 24h in upper housing 24. When lower housing 26 and upper housing 24 are engaged a compartment is defined by retaining wall 24h, hole 24g and wall 26a. A scale unit 32 is received in this compartment. Scale unit 32 will be discussed in greater detail hereafter.

When upper and lower housings 24, 26 are engaged, they define between them a cavity in which a number of components are housed. The components may include, but are not limited to, a power source 34, and a pair of slide assemblies. The power source 34 may include a compartment into which one or more batteries 34a are received and a cover 34b (FIG. 12) which encloses batteries 34a into the compartment. In other embodiments, the scale assembly 18 may be selectively engaged with an alternating current source via appropriate wiring and components provided on assembly 18.

The slide assemblies provided within the compartment formed by the engaged upper and lower housings 24, 26 may include a slider 36, a slide plate 38, and an aperture 38a which aligns with a hole 26k defined in wall 26a of lower housing 26. Slide plate 38 may also include a connector plate 38b that is received inside upper housing 24 when upper and lower housings 24, 26 are engaged. Each slider 36 may include a flange 36a that extends outwardly through slots 24j in upper housing 24 when upper and lower housings 24, 26 are engaged. Slider 36 may also be provided with a slide button 36b that protrudes through the aligned aperture 38a and hole 26k and is contactable on the lower surface of lower housing 26 (see FIG. 12). Slide button 36b may be provided with knurling or texturing on its lowermost surface. Slide button 36b is smaller than the aligned aperture 38a and hole 26k and may be selectively moved in one of a first direction and a second direction within the aligned aperture and hole. Indicators 40 are provided on the exterior surface of the wall 26a of lower housing 26. A first indicator 40a (FIG. 12) represents an unlocked position and a second indicator 40b represents a locked position. When slide button 36b is contacted by a user's finger and pushed into the unlocked position, scale assembly 18 may be unlocked or disengaged from cutting board. When slide button 36b is contacted and pushed in the opposite direction and into the locked position, scale assembly 18 is locked to cutting board 10. In this locked position, scale assembly 18 and cutting board 10 effectively are a single unit that may be lifted, moved or manipulated in any fashion as though they were only one component. When slide button 36b is moved to the unlocked position, cutting board 10 and scale assembly 18 may be separated from each other and may be used as separate units.

The locking of scale assembly 18 to cutting board 10 occurs by engaging a mechanical locking mechanism that may be provided partially on scale assembly 18 and partially on cutting board 10. In the instance illustrated in the figures, the mechanical locking mechanism comprises the depression 10h (FIG. 9) defined on cutting board 10 and the flanges 36a which protrude outwardly from left and right side walls 24e, 24f of upper housing 24. Each flange 36a may be received into one of the narrowed slots 10h″ (FIG. 9) of the depressions 10h formed in left and right side walls 10e, 10f of cutting board 10. The scale assembly 18 is unlocked from cutting board 10 when the flanges 36a move out of slots 10h″ and into the wider mouth 10h′ of the depressions 10h. Once flanges 36a reach mouths 10h′, cutting board 10 may be vertically lifted off scale assembly 18 or scale assembly 18 may be moved downwardly away from cutting board 10.

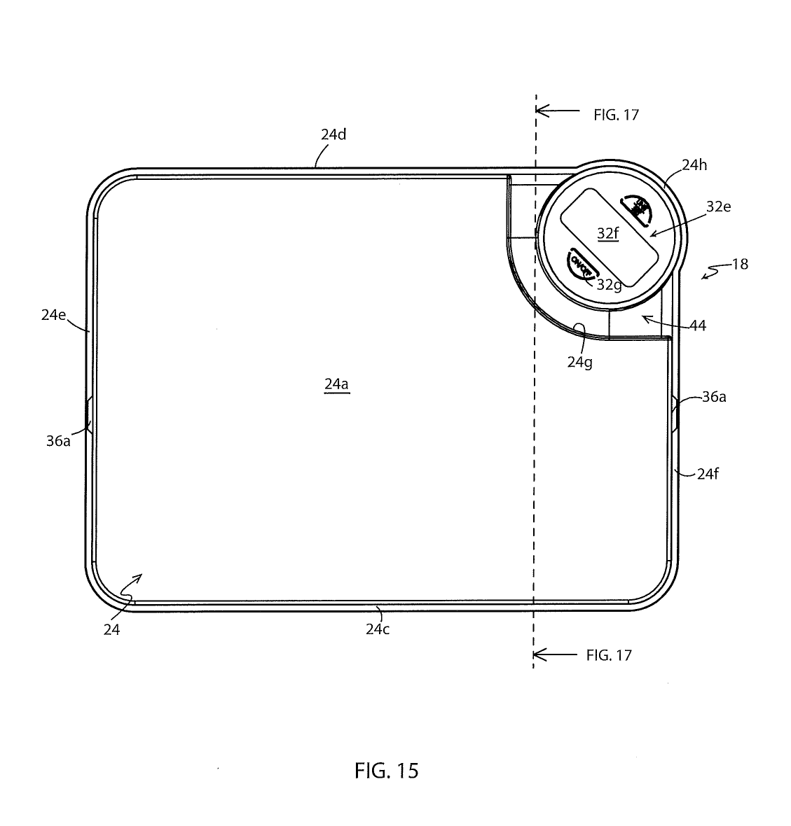

Scale unit 32 may be any suitable digital or analog scale that is sealed to ensure that it is waterproof. Scale unit 32 may include a support plate 32a, an LCD/PCB electronics assembly 32b, and various sensors 32c mounted between a housing 32d and a cover plate 32e. A strain gauge may be mounted to a lower side of the support plate 32a. The cover plate 32e may be an LCD screen cover plate and may include a display screen 32f upon which a weight may be displayed. An on/off button 32g and other controls may also be provided on cover plate 32e. As best seen in FIG. 15, housing 32d may have an angled side wall 33 that will cause cover plate 32e to be oriented at an angle α relative to the horizontal. The angle α may be from around 35° up to about 55 degrees and preferably is around 45°. This ensures that a display on display screen 32f may be more readily seen by a user. In addition, the display is in the top right hand corner of the cutting board 10 and is therefore far more visible to a user than would be the case if the display were provided in the top central region of cutting board 10.

Scale unit 32 is operatively engaged with strain gauges 30 and sensors 32c in scale unit 32 detect and display the weight of anything placed on wall 24a of scale assembly 18, or on top of top surface 10a of cutting board 10, when cutting board 10 is engaged and locked to scale assembly 18. Scale assembly 18 may be programmed in such a way that if cutting board 10 is engaged therewith, scale assembly 18 automatically compensates for the weight of cutting board 10 and zeroes the reading on display 32f.

Many people are in the habit of weighing each region of their food for a particular meal or for a week. In the past, such a person would need to find their weight scale, get a cutting board out; find a suitable bowl or container, zero the weight of the bowl or container on the scale; chop their food on the cutting board, move the cut food into the bowl or container, place the bowl or container on the scale and then weigh the same. If insufficient food is cut, they would continue to cut food on the board, transfer it into the bowl to be weighed etc. After they were finished cutting and weighing, they would need to clean up the board and the bowl and wipe off any foodstuffs spilled on the scale.

The presently disclosed cutting board 10 and scale assembly 18 combination (formed by locking the cutting board 10 and scale assembly 18 to each other) has digital strain gauges 30 built into the device and the display and controls project through the cutting board's hole 12. When a person wants to cut a quantity of food and weigh the same, they simply take out the combination cutting board scale assembly, place food on the cutting board 10, hold the food in the left hand and start to cut with a knife held in the right hand. With any movement, an auto start function provided in scale unit 32 zeroes the weight of the cutting board 10. When the user pauses in the cutting procedure and removes their left hand and uncut food from top surface 10a, the scale settles immediately and reports the weight of the cut food on cutting board 10. The user can see the display 32f easily through hole 12 in board 10. If more cut food is required, then the uncut food is placed once again on the board 10 and cutting continues. As soon as the left hand and uncut food is removed again, the scale unit 32 determines and displays the weight of the cut food left on top surface 10a.

If a different type of foodstuff is to be cut, the combination cutting board scale assembly can be quickly rinsed in the sink. The scale unit is sealed and waterproof and the cutting board and upper housing 24 protect all other components, so the scale is not damaged by the rinsing activity. When the user is finished, scale assembly 18 may be quickly detached from cutting board 10 by sliding buttons 36b towards the unlocked position (FIG. 12) and the cutting board 10 may be placed in a dishwasher to thoroughly clean and sanitize the same. Scale assembly 18 may be wiped down and stored. Other advantages of the combination cutting board scale assembly is that the footprint of the combination device is kept fairly small, the combination device can be stored sideways in a cupboard and it keeps knife cuts away from the display 32f as the display 32f is recessed within hole 12.

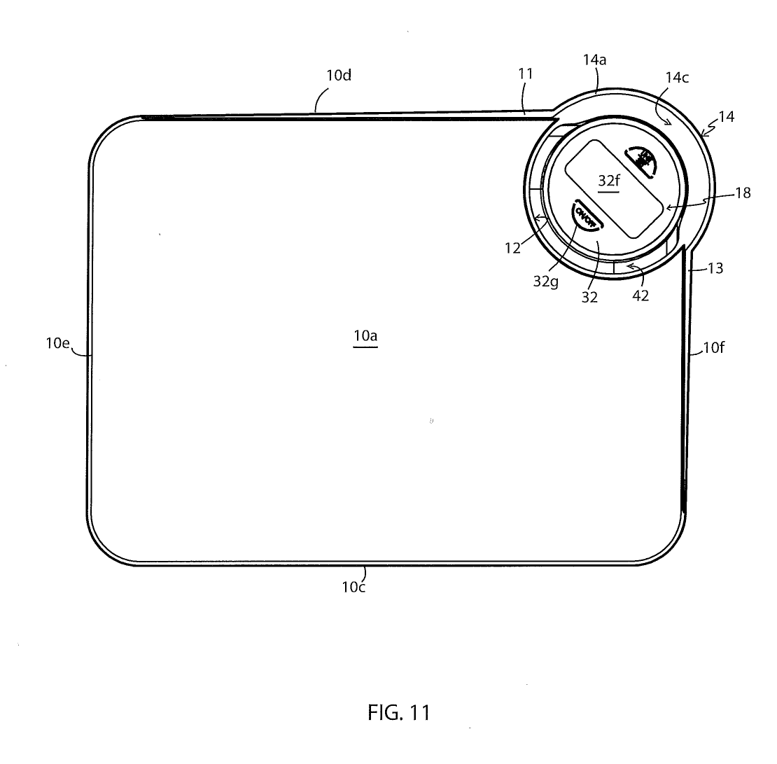

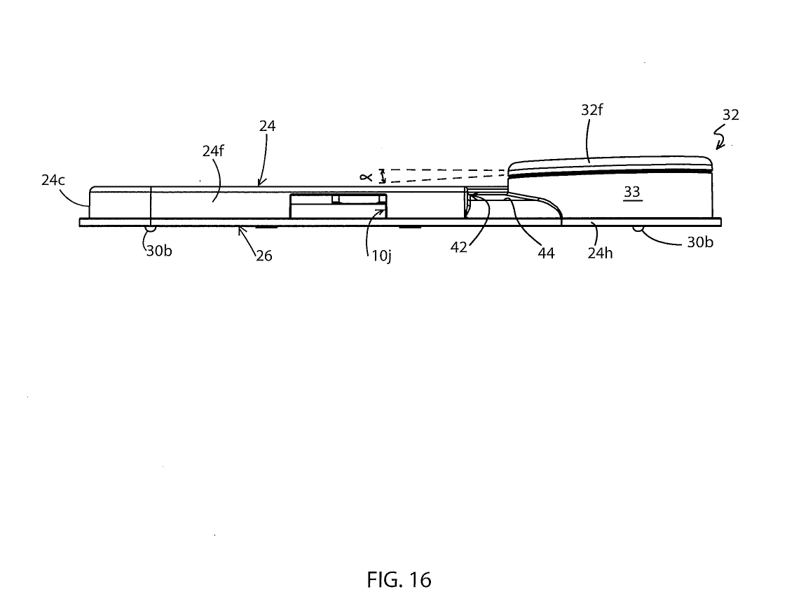

It should be noted, from FIGS. 11 and 16, since most of scale assembly 18 is covered by cutting board 10, only the top right area of scale assembly 18 around cover plate 32e and display 32f may become dirty during use. There is a large gap 42 defined between the part of wall 10a that defines hole 12 and the exterior surface of housing 32. This gap 42 allows any liquid or food that accidentally drops through hole 12 and onto scale assembly 18 to drop or flow down the angled cover plate 32e and into a sloping trough 44 (FIGS. 13, 14 and 17). Trough 44 exits at notches 16 so trough 44 will tend to guide any spilt liquid or food towards the notches 166, and ultimately onto the counter upon which the device rests. This arrangement makes clean up of scale assembly 18 relatively quick and easy.

FIGS. 20-23 show cutting board 10 being selectively engaged with a second accessory. The second accessory in question may be some type of container such as a storage container, a pot, a plastic bag, a bowl, a blender, a juicer, a grinder and so on. The container 46 illustrated in the attached figures should be understood to be representative of any type of receptacle into which it may be desired to place foodstuffs or articles that are processed on cutting board 10. As illustrated, container 46 may have a bottom wall 46a, a peripheral wall 46b extending upwardly from bottom wall 46a and a rim 46c at the upper end of wall 46b. Rim 46c defines an opening to cavity 46d and this opening may be of a similar size to the dimensions of hole 12 in cutting board 10 or may be larger or smaller than the dimensions of hole 12. Bottom and peripheral wall 46a, 46b of container may bound and define a cavity 46d into which the cut foodstuffs are to be placed for storage or further processing or cooking.

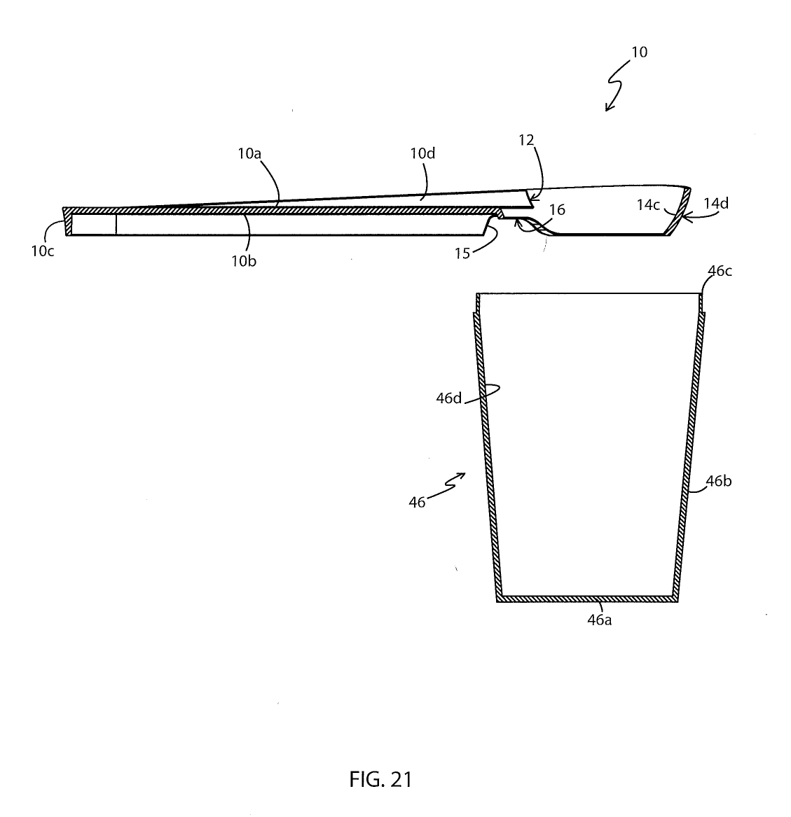

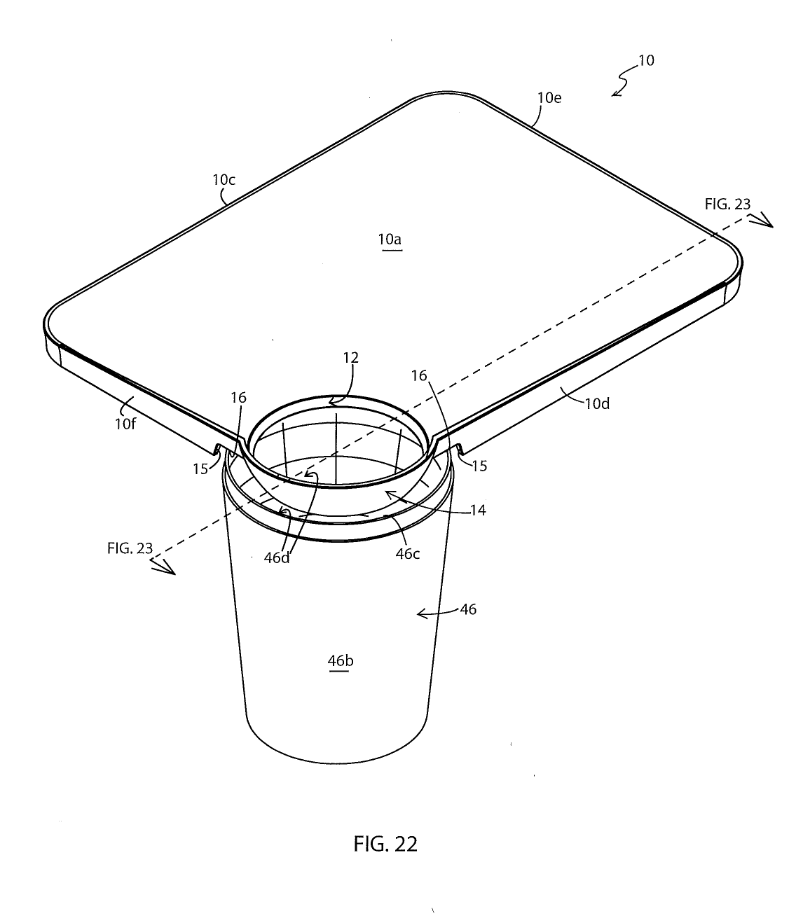

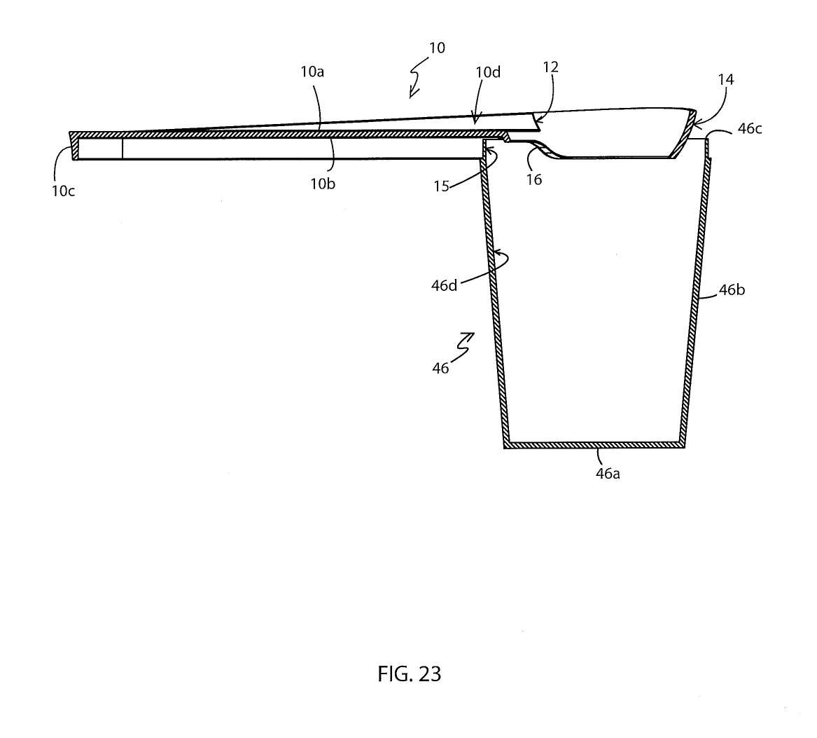

Container 46 may be positioned beneath the bottom surface 10b of cutting board 10 and particularly in a way such that hole 12 defined in cutting board 10 aligns generally with an opening to cavity 46d defined by rim 46c of container 46. This is illustrated in FIGS. 20 and 21. Cutting board 10 is then lowered in the direction of arrow “B” (FIG. 20) so that retaining wall 14 and hole 12 are seated over the opening to cavity 46d. Cutting board 10 is lowered in the direction of arrow “B” until rim 46c of container 46 is received in notches 16 defined in cutting board 10. This is illustrated in FIGS. 22 and 23. A region 15 (FIG. 23) of each of the back wall 10d and right side wall 10f that extends below bottom surface 10b of cutting board 10 may abut an exterior surface of wall 46b of container 46 proximate rim 46c. The regions 15 will aid in retaining cutting board 10 on container 46 and thereby ensure that cut foodstuffs swept into hole 12 will subsequently drop through the opening defined by rim 46c and into cavity 46d of container 46. If retaining wall 14 and the opening to container 46 are of similar size then the retaining wall may also engage a region on the inner surface of the container 46 that defines the cavity 46d.

The user may engage container 46 and cutting board 10 together in this manner after a quantity of food has been cut on top surface 10a of cutting board 10. When so desired, the user will engage container 46 with board 10 and will then sweep the cut food across top surface 10a and toward hole 12. The cut food will be corralled by lips 10d′ and 10f′ and will be funneled by retaining wall 14 into cavity 46d of container 46. If more food is to be cut into smaller pieces, cutting board 10 is disengaged from by container 46 by lifting cutting board 10 upwardly in the opposite direction to arrow “B”. Cutting board 10 is once again engaged with container 46 when additional cut food is to be moved into cavity 46d. After use, cutting board 10 may be wiped clean or put into the dishwasher after disengagement from container 46.

FIGS. 24-32 show cutting board 10 engaged with a third accessory. In this instance, the third accessory may be an overlay assembly 48. Overlay assembly 48 may be a thin plastic board that is positioned over the top surface 10a of cutting board 10. Overlay assembly 48 may frictionally engage top surface 10a of the base of cutting board 10. Although overlay assembly 48 is relatively thin because it is engaged and used on top of cutting board 10, the cutting surface of overlay assembly 48 is well supported by cutting board 10.

Overlay assembly 48 includes regions that enter into hole 12 of cutting board 10 and cover the vertical side walls 10d′, 10f′ of cutting board 10. Overlay assembly 48 allows a person to cut poultry or meat on the upper surface of the overlay assembly 48 and then lift overlay assembly 48 off cutting board 10 to dispense the cut poultry or meat. The overlay assembly 48 may be removed and the user may then use cutting board 10 for cutting vegetables or other foodstuffs. There is no need stop and clean a cutting board between working on the meat and then on the vegetables. Both the overlay assembly 48 and cutting board 10 may be dishwasher safe and therefore simple and easy to clean.

Prior to the development of the cutting board 10 and overlay assembly 48 people would tend not to cut raw meat or poultry and vegetables on the same prior art cutting surface. Typically, people would utilized two separate prior art cutting boards and cut the meat or poultry on one board and the vegetables on the other. Alternatively, people may have been tempted to turn a single prior art cutting board over, thereby placing a dirty cutting surface onto a clean counter, thereby dirtying or contaminating the counter. This methodology is no longer necessary with the provision of cutting board 10 and overlay assembly 48.

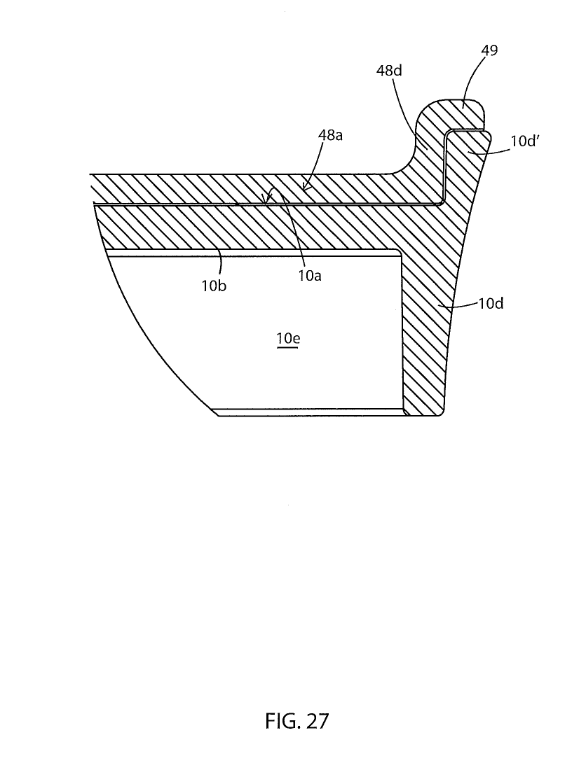

Referring still to FIGS. 24-32, overlay assembly 48 is similar to cutting board 10 except that the front wall, back wall and left and right side walls do not extend below the wall of the overlay assembly 48. Overlay assembly 48 comprises a wall having a top surface 48a, a bottom surface 48b, a front wall 48c, a back wall 48d, a left side wall 48e and a right side wall 48f. Front, back, left side and right side walls 48c, 48d, 48e, and 48f may all be oriented at right angles to top surface 48a. Like cutting board 10, back wall 48d and right side wall 48f extend for a distance upwardly beyond top surface 48a to form angled lips 48d′ and 48f′. Lips 48d′ and 48f′ may be greater than the lips 10c1′ and 10f′ and preferably include a flange 49, such as is illustrated in FIG. 27. Alternatively, lips 48d′ and 48f′ may be of the same height or of a lesser height than lips 10d′ and 10f′.

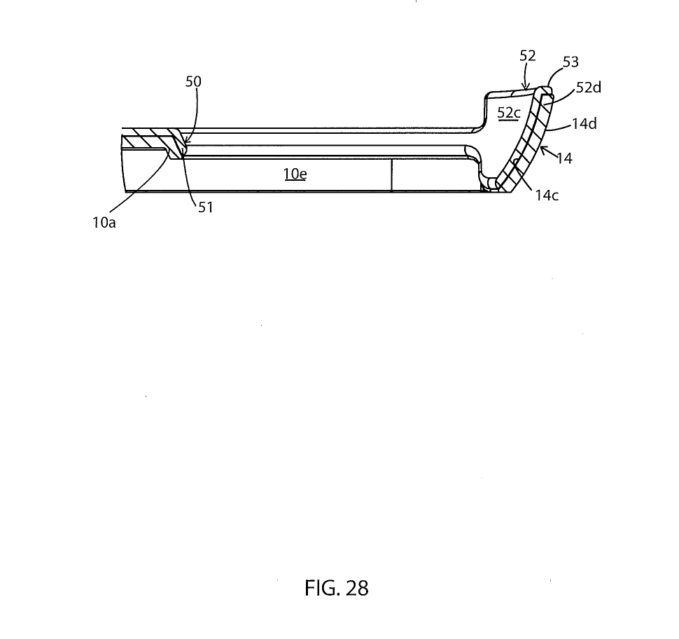

Like cutting board 10, overlay assembly 48 defines a hole 50 therein that is complementary to hole 12 and may be of a slightly larger diameter relative thereto. Preferably the region of wall 48a that defines hole 50 is formed into a flange 51 (FIG. 28) that angles downwardly into hole 50 and will therefore cover over the region of wall 10a that defines hole 12. Alternatively, hole 50 may be of substantially the same diameter as hole 12 or in some instances even smaller than hole 12. Overlay assembly 48 also includes a retaining wall 52 that is complementary to retaining wall 14 on cutting board 10. Retaining wall 52 is of the same shape, size and curvature as retaining wall 14 and is designed to be seated against the inner surface 14c of retaining wall 14 when overlay assembly 48 is placed on top of the top surface 10a of cutting board 10. Preferably, retaining wall 52 also includes a flange 53 that extends over top end 14a of retaining wall 14 as is illustrated in FIG. 28. Like cutting board 10, overlay assembly 48 also defines a pair of notches 54 that are complementary to notches 16 provided in cutting board 10. Notches 54 will align with notches 16 when overlay assembly 48 is engaged with cutting board 10. Flanges 51 and 53 help ensure that overlay assembly 48 grippingly engages cutting board 10 and does not move relative thereto during a cutting operation.

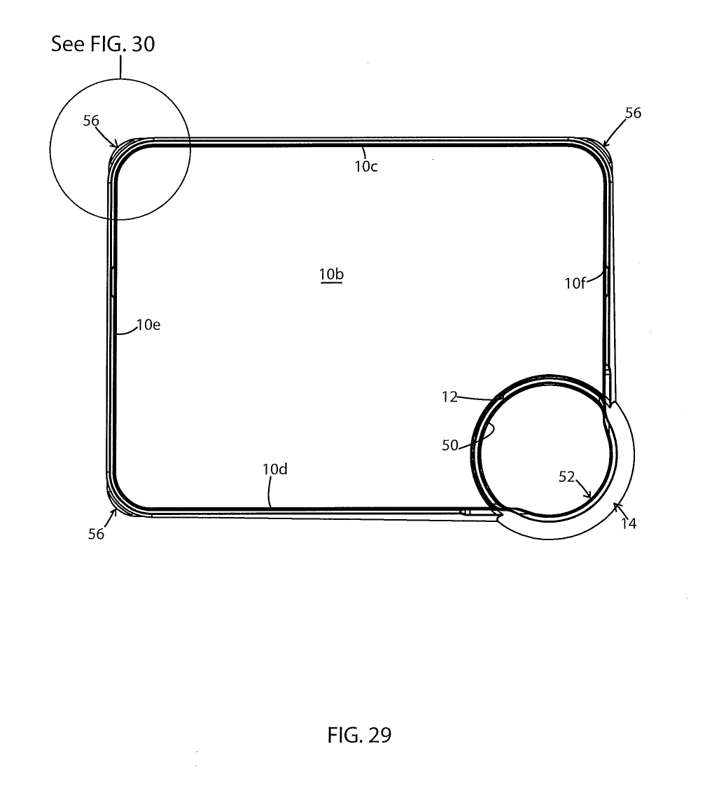

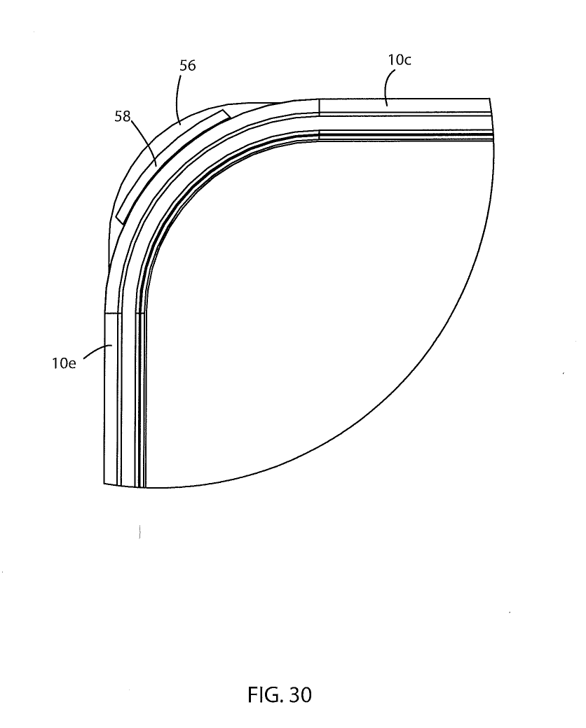

FIGS. 29-32 show that overlay assembly 48 includes tabs 56 that forms the corners of wall 48, other than the corner that defines hole 50. Tabs 56 may each include a rib 58 on its lowermost surface. Wall 48a, 48b of overlay accessory 48 is also slightly larger than wall 10a of cutting board 10. In particular, tabs 56 extend only marginally beyond the corners of cutting board 10. Ribs 58 are positioned on wall 48b in such a way as to grippingly contact an outside corner of cutting board 10, as can be seen in FIG. 30. When it is desired to remove overlay assembly 48, the user will simply grasp the slightly outwardly extending tab(s) 56 and pull overlay accessory 48 upwardly away from cutting board 10.

Although each of the three accessories, i.e., the scale assembly 18, container 46 and overlay assembly 48 have been described and illustrated as being individually used with cutting board 10, it will be understood that two or all of the accessories may be used as part of the same system. So, for example, the scale assembly 18 may be engaged with cutting board 10 and the overlay assembly 48 may be placed over the top surface 10a of cutting board 10.

An embodiment is an implementation or example of the present disclosure. Reference in the specification to “an embodiment,” “one embodiment,” “some embodiments,” “one particular embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the preferred embodiment of the disclosure are an example and the disclosure is not limited to the exact details shown or described.

1. A cutting board comprising:
a base having a top surface and a bottom surface;
a hole defined in the base, wherein the hole extends between the top surface and the bottom surface; and
a retaining wall provided on the base; said retaining wall partially circumscribing the hole.

2. The cutting board as defined in claim 1, wherein the retaining wall extends for a distance above the top surface of the base or extends for a distance below the bottom surface of the base.

3. The cutting board as defined in claim 1, wherein the retaining wall extends for a distance above the top surface of the base and for distance below the bottom surface of the base.

4. The cutting board as defined in claim 1, wherein the retaining wall is arcuate in shape.

5. The cutting board as defined in claim 1, wherein the retaining wall has a top end, a bottom end; an arcuate inner surface and an arcuate outer surface, wherein the inner and outer surfaces extend between the top end and the bottom end; and wherein the top end of the retaining wall is displaced laterally outwardly from the bottom end of the retaining wall.

6. The cutting board as defined in claim 1, wherein the base includes a front wall, a back wall, a left side wall and a right side wall; and wherein a region of one or more of the back wall and the right side wall or the left side wall extends for a distance above the top surface of the base.

7. The cutting board as defined in claim 6, wherein the region of the one or more of the back wall and the right or left side walls that extends above the top surface of the base is wedge-shaped.

8. The cutting board as defined in claim 7, wherein the wedge-shaped region of the one or more of the back wall and the right or left side walls is integral with or connected to the retaining wall and tapers away from the retaining wall.

9. The cutting board as defined in claim 1, wherein the retaining wall is shaped to funnel objects through the hole defined in the base.

10. The cutting board as defined in claim 1, further comprising at least one notch defined in a bottom end of the retaining wall or at an intersection of the bottom end of the retaining wall and a back wall, a right side wall or a left side wall provided on the base.

11. In combination,
a cutting board; and
an accessory selectively engageable with the cutting board;
wherein the cutting board comprises:
a base having a top surface and a bottom surface;
a hole defined in the base, wherein the hole extends between the top and bottom surfaces; and
a retaining wall provided on the base; said retaining wall partially circumscribing the hole.

12. The combination as defined in claim 11, wherein the accessory is a scale assembly and a first part of the scale assembly extends for a distance into the hole defined by the base; and a second part of the scale assembly extends for a distance beneath the bottom surface of the base.

13. The combination as defined in claim 12, further comprising a locking mechanism provided on one or both of the scale assembly and the cutting board; and wherein the locking mechanism is engaged to lock the cutting board and scale assembly together; and the locking mechanism is disengaged to release the cutting board from the scale assembly.

14. The combination as defined in claim 11, wherein the accessory is a container that is positionable beneath the hole in the cutting board, wherein the container extends for a distance downwardly from the bottom surface of the base when the container is engaged with the cutting board.

15. The combination as defined in claim 14, wherein the base defines a perimeter wall that extends downwardly from the bottom surface thereof; and wherein a notch is defined in a bottom end of the retaining wall or in a bottom edge of the perimeter wall adjacent the retaining wall; and wherein an upper rim of the container is receivable in the notch.

16. The combination as defined in claim 11, wherein the accessory comprises an overlay assembly; and wherein the overlay assembly includes a wall with a top surface and a bottom surface, wherein the bottom surface of the wall is positioned above the top surface of the base of the cutting board.

17. The combination as defined in claim 16, wherein the overlay assembly defines a hole therein that extends between the top surface and bottom surface of the wall; and wherein the hole in the overlay assembly is aligned with the hole defined in the cutting board when the overlay assembly is placed on the top surface of the cutting board.

18. The combination as defined in claim 16, wherein the overlay assembly further defines a retaining wall that is complementary in size and shape to the retaining wall of the cutting board and is placed in abutting contact with an inner surface of the retaining wall on the cutting board when the overlay assembly is placed on the top surface of the cutting board.

19. A method of measuring a quantity of foodstuffs comprising:
providing a cutting board having a base with a top surface and a bottom surface; a hole defined in the base and extending between the top and bottom surfaces; and a retaining wall provided on the base; said retaining wall partially circumscribing the hole;
selectively placing the cutting board over a top wall of a scale assembly;
locking the cutting board to the scale assembly with a locking mechanism;
cutting foodstuffs on the top surface of the base; and
weighing the cut foodstuffs on the top surface of the base with a scale provided in the scale assembly and without disengaging the cutting board from the scale assembly.

20. The method as defined in claim 19, further comprising:
disengaging the locking mechanism;
separating the cutting board from the scale assembly; and
moving cut foodstuffs across the cutting board to the hole; and
funneling the cut foodstuffs through the hole and off the cutting board.

21. The method as defined in claim 19, further comprising:
extending a display on the scale assembly into the hole of the cutting board; and
viewing a weight of the cut foodstuffs by observing the display in the hole.

22. The method as defined in claim 19, further comprising:
immersing the locked cutting board and scale assembly in water to clean the top surface of the cutting board; and
keeping electronics in the scale assembly dry while immersing the locked cutting board and scale assembly.
